(19) United States
(12) Patent Application Publication
(10) Pub. No.: US 2014/0078020 A1
(43) Pub. Date: Mar. 20, 2014

(54) TERMINAL APPARATUS, INTEGRATED CIRCUIT, AND COMPUTER-READABLE RECORDING MEDIUM HAVING STORED THEREIN PROCESSING PROGRAM

(71) Applicant: FUJITSU LIMITED, Kawasaki-shi (JP)

(72) Inventor: Takuma YAMADA, Kawasaki (JP)

(73) Assignee: FUJITSU LIMITED, Kawasaki-shi (JP)

(21) Appl. No.: 14/016,694

(22) Filed: Sep. 3, 2013

(30) Foreign Application Priority Data
Sep. 20, 2012 (JP) 2012-206747

(51) Int. Cl. G06F 3/147

(52) U.S. Cl. CPC G06F 3/147
USPC 345/1.1

(57) ABSTRACT

A terminal apparatus includes an integrated circuit installed with a first encoder executing first encode processing for transmitting a content of which display processing is performed by a display processing unit to a receiving device.

### CROSS-REFERENCE TO RELATED APPLICATION

This application is based upon and claims the benefit of priority of the prior Japanese Patent Application No. 2012-206747, filed on Sep. 20, 2012, the entire contents of which are incorporated herein by reference.

### FIELD

The invention is related to a terminal apparatus, integrated circuit, and a computer-readable recording medium having stored therein a processing program.

### BACKGROUND

In recent years, in addition to a television or a personal computer (PC), terminal apparatuses such as a smart phone, a tablet PC (hereinafter, simply referred to as a “tablet”), and the like have been spread. A screen displayed in the terminal apparatus may be displayed (screen-mirrored) in a display device such as a display of the television or the PC, and a lot of persons can use contents such as video or sound or various services. Note that, the terminal apparatus may include a smart phone or a tablet which is operated by an Android (registered trademark) OS, or the like.

As a method for performing the screen mirroring, a method for connecting the terminal apparatus as a mirroring source and the display device as a mirroring destination by using a high-definition multimedia interface (HDMI) cable or an HDMI conversion adapter is known.

Further, as a technology for remotely operating the PC which is distant on a network, virtual network computing (VNC) is known. In the VNC, screen data of a desktop, or the like is transmitted from a mirroring source as a VNC server and the VNC server accepts processing from a mirroring destination as a VNC client, and the VNC client remotely operates the VNC server based on the received screen data. FIG. 23 is a flowchart describing an operating example of image processing in the VNC server. Note that, in FIG. 23, one-frame processing is illustrated.

As illustrated in FIG. 23, in the VNC server, a frame transmitted to the VNC client is compared with a previous frame (step S101) and an update block is determined from a difference from the previous frame (step S102). In addition, the VNC server determines whether there is a remaining processing block (step S103). In the case where there is no remaining processing block (route No of step S103), for example, in the case where the update block is not determined in step S102, one-frame processing ends. On the other hand, in the case where there is the remaining processing block (route Yes of step S103), the VNC server determines whether a single color is provided in the update block (step S104).

In the case where the single color is provided in the update block (route Yes of step S104), the VNC server fills a rectangle of the update block and transmits the filled rectangle to the VNC client and the process proceeds to step S103 (step S105). On the other hand, in the case where the single color is not provided in the update block (route No of step S104), the VNC server retrieves an image near to the update block from the previous frame to detect motion correction (step S106) and determines whether the image near to the update block is present in the previous frame, that is, whether the motion correction is performed (step S107).

In the case where the image near to the update block is present in the previous frame, that is, in the case where the motion correction is performed (route Yes of step S107), the VNC server transmits a command to copy a rectangle of a corresponding area in the previous frame to the VNC client and the process proceeds to step S103 (step S108). On the other hand, in the case where no image near to the update block is present in the previous frame, that is, in the case where the motion correction is not performed (route No of step S107), the VNC server compresses a block image (step S109) and transmits a command to draw the rectangle together with the compressed image to the VNC client, and the process proceeds to step S103 (step S110).

The VNC server executes the processing for each frame to transmit image data of the mirroring source to the VNC client. Performing the screen mirroring by using the VNC is also considered.

FIG. 24 is a diagram illustrating a configuration example of a communication system 100-1 that performs screen mirroring among apparatuses by the VNC, and FIG. 25 is a diagram illustrating a configuration example of a communication system 100-2 that performs screen mirroring among the apparatuses by the HDMI. As illustrated in FIG. 24, the communication system 100-1 includes a terminal apparatus 1000-1 as the mirroring source and a display device 2000-1 as the mirroring destination. Further, as illustrated in FIG. 25, the communication system 100-2 includes a terminal apparatus 1000-2 as the mirroring source and a display device 2000-2 as the mirroring destination. Hereinafter, in the case where the communication systems 100-1 and 100-2 are not distinguished from each other, the communication systems 100-1 and 100-2 are simply referred to as a communication system 100. Further, in the case where the terminal apparatuses 1000-1 and 1000-2 are not distinguished from each other, the terminal apparatuses 1000-1 and 1000-2 are simply referred to as a terminal apparatus 1000, and in the case where the display devices 2000-1 and 2000-2 are not distinguished from each other, the display devices 2000-1 and 2000-2 are simply referred to as a display device 2000.

In the example illustrated in FIG. 24, the terminal apparatus 1000-1 and the display device 2000-1 are connected to each other via a local area network (LAN), for example, a wireless LAN 1000a. Further, in the example illustrated in FIG. 25, the terminal apparatus 1000-2 and the display device 2000-2 are connected to each other via a cable 1000b such as the HDMI cable or the HDMI adapter. Hereinafter, screen mirroring between the terminal apparatus 1000-1 and the display device 2000-1 will be described on the assumption that the communication system 100-1 illustrated in FIG. 24 executes the VNC via the wireless LAN 1000a. In addition, screen mirroring between the terminal apparatus 1000-2 and the display device 2000-2 will be described on the assumption that the communication system 100-2 illustrated in FIG. 25 executes an HDMI output via the cable 1000b.

As illustrated in FIG. 24, the terminal apparatus 1000-1 includes an application 1100-1, a library 1200, a driver 1300-1, a display processing unit 1400-1, a display unit 1500, and a transmitter 1600. Further, the display device (receiving device) 2000-1 includes an application 2100-1, a library 2200, a driver 2300-1, a display processing unit 2400-1, a display unit 2500-1, and a receiver 2600.

On the other hand, as illustrated in FIG. 25, the terminal apparatus 1000-2 includes an application 1100-2, a library 1200, a driver 1300-2, a display processing unit 1400-2, and a display unit 1500. Further, the display device (receiving device) 2000-2 includes an application 2100-2, a library 2200, a driver 2300-2, a display processing unit 2400-2, and a display unit 2500-2.

First, a common function of each component illustrated in FIGS. 24 and 25 will be described. Note that, in the following description, “−1” or “−2” of an end of a reference numeral of each component is not written, for convenience. For example, in the case where a common function of the applications 1100-1 and 1100-2 is described, the applications 1100-1 and 1100-2 will be written as an application 1100. The same is applied even to other components.

The applications 1100 and 2100 are software that generate or manage contents in the terminal apparatus 1000 and the display device 2000, respectively. The libraries 1200 and 2200 are common interfaces that are positioned on an intermediate layer between the application 1100 and the driver 1300 and between the application 2100 and the driver 2300, respectively. The drivers 1300 and 2300 are software that control hardware of the terminal apparatus 1000 and the display device 2000, respectively.

The display processing units 1400 and 2400 execute display processing for displaying the contents from the applications 1100 and 2100 on the display units 1500 and 2500, respectively. Note that, as the display processing units 1400 and 2400, for example, a graphics processing unit (GPU) or a display controller (hereinafter, referred to as a DC) may be used, respectively. The display units 1500 and 2500 display the contents subjected to the display processing by the display processing units 1400 and 2400, respectively. The display units 1500 and 2500 may include displays such as a liquid crystal display (LCD).

Further, each component illustrated in FIG. 24 has the following function, in addition to the common function of each component of FIGS. 24 and 25.

The application 1100-1 includes a function of the VNC server, and the application 2100-2 includes a function of the VNC client. The driver 1300-1 has a function to transfer the content generated by the application 1100-1 as the VNC server to the transmitter 1600. Further, the driver 2300-1 has a function to receive a content received by the receiver 2600 and transfer the received content to the display processing unit 2400-1.

The display processing unit 2400-1 executes display processing for even a content (image information) that the driver 2300-1 receives from the VNC server (terminal apparatus 1000-1) via the wireless LAN 1000a and the receiver 2600. The transmitter 1600 transmits the content generated by the application 1100-1 as the VNC server to the display device 2000 via the wireless LAN 1000a. The receiver 2600 receives the content from the transmitter 1600 and transfers the received content to the driver 2300-1.

By the above configuration, the communication system 100-1 illustrated in FIG. 24 may display (perform screen-mirroring) a screen displayed in the terminal apparatus 1000-1 onto the display device 2000-1 by the VNC using the wireless LAN 1000a.

On the other hand, each component illustrated in FIG. 25 has the following function, in addition to the common function of each component of FIGS. 24 and 25.

The display processing unit 1400-2 has a function to transmit a content subjected to the display processing to the display device 2000 via the cable 1000b. Further, the display unit 2500-2 may display the content received via the cable 1000b.

By the above configuration, the communication system 100-2 illustrated in FIG. 25 may display (perform screen-mirroring) a screen displayed in the terminal apparatus 1000-2 onto the display device 2000-2 by the HDMI using the cable 1000b.

Next, the display processing and storage processing of contents in the terminal apparatus 1000-1 illustrated in FIG. 24 will be described. FIG. 26 is a diagram illustrating a hardware configuration example of the terminal apparatus 1000-1 illustrated in FIG. 24, and FIG. 27 is a flowchart describing an operating example of the display processing and the storage processing of the content by the terminal apparatus 1000-1 illustrated in FIG. 26.

As illustrated in FIG. 26, the terminal apparatus 1000-1 includes a system-on-a-chip (SoC) 3000, a camera 5100, and a synchronous dynamic random access memory (SDRAM) 5200. Further, the terminal apparatus 1000-1 includes a flash memory 5300, a wireless fidelity (Wi-Fi) controller 5400, and an LCD 1500.

The camera 5100 is an imaging device that photographs a still image or a moving image (a movie and a video) and converts the photographed still image or moving picture into an electric signal, and outputs the electric signal to the SoC 3000 as a content. The SDRAM 5200 is an example of a volatile memory that temporarily holds the content photographed by the camera 5100. The flash memory 5300 is an example of a nonvolatile memory that stores a content which is photographed by the camera 5100 and subjected to predetermined processing by the SoC 3000. The Wi-Fi controller 5400 is a controller that transmits and receives data to/from the display device 2000-1 by Wi-Fi communication and is an example of the transmitter 1600 illustrated in FIG. 24.

The SoC 3000 includes an L3 interconnect 3100, a central processing unit (CPU) 3200, an imaging processor 3300, a GPU 3400, and a DC 3500. Further, the SoC 3000 includes an H.264 encoder 3600, a NAND controller 3700, and an Ethernet (registered trademark) media access controller (EMAC) 3800.

The L3 interconnect 3100 is a high-speed interface that connects circuit blocks on the SoC 3000. Respective blocks of reference numerals 3200 to 3800 illustrated in FIG. 26, and the SDRAM 5200 are connected to each other via the L3 interconnect 3100. The CPU 3200 is one example of a processor that executes a predetermined program stored in the SDRAM 5200 to execute various processing in the terminal apparatus 1000-1. Note that, a micro processing unit (MPU) may be used, instead of the CPU 3200.

The imaging processor 3300 is a processor that executes predetermined processing such as noise correction or filter processing to the content photographed by the camera 5100 to hold the executed processing in the SDRAM 5200. The GPU 3400 is a processor that executes drawing processing of the content held by the SDRAM 5200 for displaying the content on the LCD 1500. The DC 3500 is a controller that outputs the content subjected to the drawing processing by the GPU 3400 to the LCD 1500. The GPU 3400 and the DC 3500 are examples of the display processing unit 1400-1 illustrated in FIG. 24.

The H.264 encoder 3600 is an encoder that performs encode (compression) processing of an H.264 format for the content of the moving image (movie) held by the SDRAM 5200. The NAND controller 3700 is a controller that controls writing and reading in and from the flash memory 5300 and stores the content encoded by the H.264 encoder 3600 in the flash memory 5300. The EMAC 3800 is a controller that controls transmission/reception between the CPU 3200 and an Ethernet (registered trademark) network, and controls transmission/reception between the CPU 3200 and the Wi-Fi network through the Wi-Fi controller 5400 in the example illustrated in FIG. 26.

Note that, the LCD 1500 displays the content subjected to the display processing by the GPU 3400 and the DC 3500 and is one example of the display unit 1500 illustrated in FIG. 24.

In the terminal apparatus 1000-1 configured as above, display processing and storage processing of the content are executed, as illustrated in FIG. 27. Note that, FIG. 27 illustrates processing in the case where the content of the moving image (movie) is photographed by the camera 5100.

As illustrated in FIG. 27, when the camera 5100 photographs (generates) the content (step S111), the imaging processor 3300 executes image processing of the content (step S112) and holds an image processing result in the SDRAM 5200 (step S113).

Subsequently, the GPU 3400 executes drawing processing of the content held by the SDRAM 5200 (step S114) and the DC 3500 outputs a drawing result to the LCD 1500 (step S115). Then, the LCD 1500 displays an output result (step S116) and the process ends.

On the other hand, the H.264 encoder 3600 executes encoding of the H.264 format for the content held by the SDRAM 5200 (step S117) and an encoding result is held in the flash memory 5300 (step S118), and the processing is completed.

Note that, since FIG. 27 illustrates processing for one frame in the terminal apparatus 1000-1, the terminal apparatus 1000-1 performs processing illustrated in FIG. 27 for all frames of the content.

By the configuration example and the operating example, in the terminal apparatus 1000-1, the display processing of the content on the LCD 1500 and the storage processing of the content in the flash memory 5300 are performed. Note that, the terminal apparatus 1000-2 illustrated in FIG. 25 may include the same configuration and perform the same operation as illustrated in FIGS. 26 and 27.

Further, as the related technology, a technology which relates to power management of a system-on-chip and in which a slave unit connected to an interconnect controls a power status in response to a signal for designating a time interval from a transaction until a subsequent transaction is sent is known (see, for example, Patent Literature 1). According to the technology, trade-off between power on the system-on-chip and a delay is reduced to manage the power and further, a central power controller may not be required.

Further, as another related technology, a technology in which an arbitration circuit selects a predetermined transaction by using priority levels associated with each of a plurality of transactions, respectively, among the plurality of transactions issued in a share resource from a master device is known (see, for example, Patent Literature 2).
[Patent Literature 1] Japanese National Publication of International Patent Application No. 2009-545048
[Patent Literature 2] Japanese Laid-open Patent Publication No. 2011-65649

As described above, technologically, the screen displayed in the terminal apparatus 1000-1 corresponding to the Android OS may be displayed in the display device 2000-1 by the VNC technology, but convenience may be damaged by problems described in (i) to (iv) below.

(i) In the VNC, since only a block which is changed is updated and further, an output timing from a VNC server is different for each block, a display failure including a block shape occurs in the screen displayed in the display device 2000-1.

(ii) A delay width of one to dozens of frames is generated by the number of updated blocks or a processing flow in image processing in the VNC server. That is, a delay of approximately a maximum of tens of frames (several seconds) occurs in the screen display in the display device 2000-1.

(iii) In the VNC, an operation may be performed at a transmission speed of 2 Mbps or more, but dozens Mbps or more is required to display a high-resolution moving image. Therefore, the image processing in the VNC server does not keep time in the high-resolution moving image and a skipping operation of several to dozens of frames is performed. As a result, it is difficult to display a multimedia content such as a movie in the display device 2000-1 by using the VNC technology.

(iv) Since each processing including a high load, such as an interframe difference, motion correction, and image compression in the VNC server is performed by software, usage rate of the MPU (CPU 1500) of the terminal apparatus 1000-1 is increased. As a result, the MPU uses a large amount of MPU resource which is common with the application 1100-1 and the operating system (OS) and exerts a large influence on operations of the application 1100-1 and the OS.

On the other hand, in the case where the screen displayed in the terminal apparatus 1000-2 via the cable 1000b is displayed in the display device 2000-2 by an HDMI, the multimedia contents may be displayed in the display device 2000-2. For example, in the case where the content of the moving image at output of 1080p, 30 fps, and 24 bit is output from a display control unit 1400-2 illustrated in FIG. 25, uncompressed data is output at a transmission speed of approximately 1.5 Gbps. On the other hand, the cable 1000b such as the HDMI cable or the HDMI adapter may transmit the content of the moving image at the transmission speed of approximately 1.5 Gbps.

However, in the case where the content of the moving image is transmitted by the HDMI, since the terminal apparatus 1000-2 and the display device 2000-2 are physically connected with each other by the cable 1000b, the positional relationship between the terminal apparatus 1000-2 and the display device 2000-2 is limited and convenience deteriorates.

As such, in each of the technologies described above, in screen mirroring in which the content displayed in the terminal apparatus 1000 is displayed in the display device (receiving device) 2000, the convenience deteriorates.

Further, in each of the related technologies described above, the aforementioned problems are not considered.

### SUMMARY

According to an aspect of the embodiments, a terminal apparatus includes an integrated circuit installed with a first encoder executing first encode processing for transmitting a content of which display processing is performed by a display processing unit to a receiving device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example of a communication system according to an embodiment;

FIG. 2 is a diagram illustrating a hardware configuration example of a terminal apparatus illustrated in FIG. 1;

FIG. 3 is a flowchart describing operating examples of display processing, storage processing, and transmission processing of a content by the terminal apparatus illustrated in FIG. 2;

FIG. 4 is a flowchart describing an operating example of encode processing by an M-JPEG encoder illustrated in FIG. 2;

FIG. 5 is a diagram illustrating a hardware configuration example of a terminal apparatus according to a first example of an embodiment;

FIG. 6 is a flowchart describing operating examples of display processing, storage processing, and transmission processing of a content by the terminal apparatus illustrated in FIG. 5;

FIG. 7 is a sequence diagram describing operating examples of the display processing, the storage processing, and the transmission processing of the content by the terminal apparatus illustrated in FIG. 5;

FIG. 8 is a diagram illustrating a hardware configuration example of a display device according to the first example of the embodiment;

FIG. 9 is a flowchart describing operating examples of reception processing and display processing of a content by the display device illustrated in FIG. 8;

FIG. 10 is a sequence diagram describing operating examples of the reception processing and the display processing of the content by the display device illustrated in FIG. 8;

FIG. 11 is a diagram illustrating a hardware configuration example of a terminal apparatus according to a second example of the embodiment;

FIG. 12A is a diagram illustrating an example of common processing of encode by the hardware accelerator illustrated in FIG. 11;

FIG. 12B is a diagram illustrating a configuration example of a hardware accelerator illustrated in FIG. 11;

FIG. 13 is a flowchart describing an operating example of encode processing by the hardware accelerator illustrated in FIG. 11;

FIG. 14 is a flowchart describing operating examples of display processing, storage processing, and transmission processing of a content by the terminal apparatus illustrated in FIG. 11;

FIG. 15 is a sequence diagram describing the operating examples of the display processing, the storage processing, and the transmission processing of the content by the terminal apparatus illustrated in FIG. 11;

FIG. 16 is a diagram illustrating a hardware configuration example of a terminal apparatus according to a third example of the embodiment;

FIG. 17 is a flowchart describing operating examples of display processing, storage processing, and transmission processing of a content by the terminal apparatus illustrated in FIG. 16;

FIG. 18 is a sequence diagram describing the operating examples of the display processing, the storage processing, and the transmission processing of the content by the terminal apparatus illustrated in FIG. 16;

FIG. 19 is a diagram illustrating one example of a communication amount of an internal bus of an SoC in a terminal apparatus according to the embodiment and the first to third examples;

FIG. 20 is a diagram illustrating one example of the communication amount of the internal bus of the SoC in the terminal apparatus according to the first example of the embodiment;

FIG. 21 is a diagram illustrating one example of the communication amount of the internal bus of the SoC in the terminal apparatus according to the second example of the embodiment;

FIG. 22 is a diagram illustrating one example of the communication amount of the internal bus of the SoC in the terminal apparatus according to the third example of the embodiment;

FIG. 23 is a flowchart describing an operating example of image processing in the VNC server;

FIG. 24 is a diagram illustrating a configuration example of a communication system that performs screen mirroring by VNC among apparatuses;

FIG. 25 is a diagram illustrating a configuration example of a communication system that performs screen mirroring by an HDMI among apparatuses;

FIG. 26 is a diagram illustrating a hardware configuration example of a terminal apparatus illustrated in FIG. 24; and

FIG. 27 is a flowchart describing operating examples of display processing and storage processing of a content by the terminal apparatus illustrated in FIG. 26.

### DESCRIPTION OF EMBODIMENTS

Hereinafter, embodiments will be described with reference to the drawings.

### [1] Embodiment

### [1-1] Description of Communication System

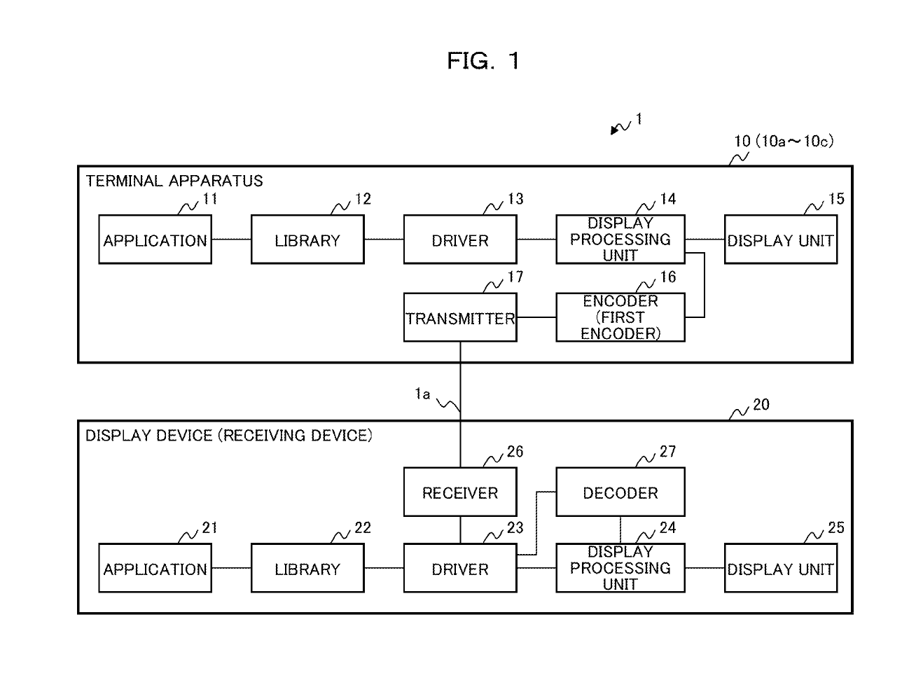

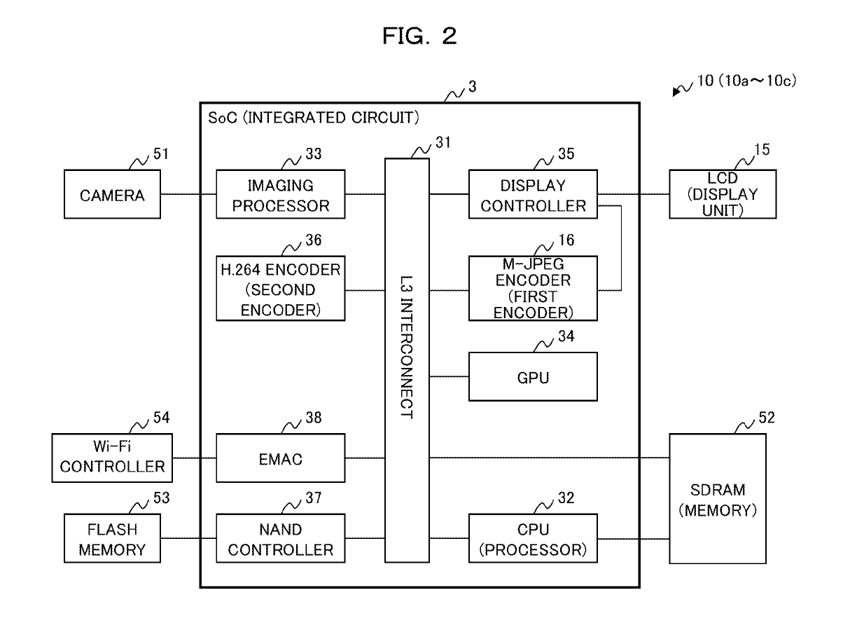

FIG. 1 is a diagram illustrating a configuration example of a communication system 1 according to an embodiment, and FIG. 2 is a diagram illustrating a hardware configuration example of a terminal apparatus 10 (10a to 10c) illustrated in FIG. 1. As illustrated in FIG. 1, a communication system 1 includes a terminal apparatus 10 (10a to 10c) and a display device 20. Note that, the terminal apparatuses 10a to 10c are terminal apparatuses according to first to third examples to be described below, respectively, but a basic configuration is common with the terminal apparatus 10 according to the embodiment. In the following description, in the case where the terminal apparatus 10 and the respective terminal apparatuses 10a to 10c to be described below are distinguished from each other, the terminal apparatuses 10a to 10c are simply referred to as the terminal apparatus 10.

In the embodiment, the communication system 1 performs screen mirroring of displaying a screen displayed on the terminal apparatus 10 as a mirroring source on the display device 20 as a mirroring destination.

The terminal apparatus 10 and the display device 20 are connected to each other via a network such as a LAN (preferably, a wireless LAN). Hereinafter, a case in which the communication system 1 performs screen mirroring between the terminal apparatus 10 and the display device 20 via Wi-Fi communication 1a will be described.

The terminal apparatus 10 includes an application 11, a library 12, a driver 13, a display processing unit 14, a display unit 15, an encoder 16, and a transmitter 17, as illustrated in FIG. 1. Further, display device (receiving device) 20 includes an application 21, a library 22, a driver 23, a display processing unit 24, a display unit 25, a receiver 26, and a decoder 27, as illustrated in FIG. 1.

Note that, the terminal apparatus 10 may include a mobile information processing apparatus such as a smart phone, a tablet, or a notebook. In addition, as the terminal apparatus 10, a stationary information processing apparatus such as a desktop PC or a server may be used. In the embodiment, the terminal apparatus 10 will be described as the smart phone or the tablet operated by an Android OS.

Further, the display device 20 may include a device that may receive and display a content from the terminal apparatus 10, such as a television, the smart phone, the tablet, or a PC.

Further, the content is information including a still image, a moving image (a movie or a video) or sound (audio), or any combination thereof. Hereinafter, in the embodiment, the content will be described as a multimedia content including the movie and the audio.

The applications 11 and 21 are software that generate or manage the content in the terminal apparatus 10 and the display device 20, respectively. For example, the application 11 has a function to control execution of moving photographing by a camera 51 (see FIG. 2), screen displaying on the display unit 15, and screen mirroring output via the Wi-Fi communication 1a. Further, the application 21 has a function to control execution of screen mirroring input via the Wi-Fi communication 1a and screen displaying on the display unit 25.

The libraries 12 and 22 are common interfaces that are positioned on an intermediate layer between the application 11 and the driver 13 and between the application 21 and the driver 23, respectively. The driver 13 is software that controls hardware of the terminal apparatus 10. The display processing unit 14 executes display processing for displaying the content from the application 11 on the display unit 15. The display units 15 and 25 display the contents subjected to the display processing by the display processing units 14 and 24, respectively. The display units 15 and 25 may include a display such as a LCD, a projector, or the like.

The encoder (first encoder) 16 executes encode (compression) processing (first encode processing) for transmitting the content (content after display processing) subjected to the display processing in the display processing unit 14 to the display device 20.

The transmitter 17 transmits the content subjected to the encode processing by the encoder 16 to the display device 20 via the Wi-Fi communication 1a. The receiver 26 receives the content from the transmitter 17 and transfers the received content to the driver 23. The driver 23 is software that controls hardware of the display device 20. Further, the driver 23 receives the content received by the receiver 26 and transfers the received content to the decoder 27.

The decoder 27 decodes the content received from the driver 23 in a format encoded by the encoder 16. The display processing unit 24 executes display processing for displaying the content from the application 21 on the display unit 25. Further, the display processing unit 24 also executes display processing of the content decoded by the decoder 27. Note that, the display processing units 14 and 24 may include, for example, a GPU and a display controller (DC).

By the above configuration, the communication system 1 may execute screen mirroring of displaying the screen displayed on the terminal apparatus 10, on the display device 20.

Note that, the receiver 26 may transfer the content received from the transmitter 17 to not the driver 23 but the library 22.

In addition, the encoding by the encoder 16 is preferably performed in a format including high compression rate. The reason is that the wireless LAN such as the Wi-Fi communication 1a is lower than communication via a cable such as an HDMI in transmission speed.

For example, HDMI of 1.0 to 1.2 has a transmission speed at a maximum of 4.95 Gbps and HDMI of 1.3 to 1.4 has a transmission speed at a maximum of 10.2 Gbps. As one example, in the case where contents of uncompressed moving images of output of 1080 p, 30 fps, and 24 bit are output from the terminal apparatus 10, the content of the uncompressed moving image is transmitted at a transmission speed of approximately 1.5 Gbps as described above, in accordance with the HDMI.

On the other hand, in Wi-Fi communication defined as IEEE 802.11n, a rated speed is in the range of 65 to 600 Mbps (however, an effective speed is approximately ⅓ less than approximately a half of the rated speed).

In the above point, the encoding by the encoder 16 preferably targets compression rate approximately in the range of 1/20 to 1/30. A format of satisfying a condition of the compression rate may include a Motion-Joint Photographic Experts Group (M-JPEG) format. Hereinafter, in the embodiment, the encoder 16 executes M-JPEG format encoding of the transmitted content, and the decoder 27 executes M-JPEG format decoding of the received content.

### [1-2] Configuration Example of Terminal Apparatus

Next, a hardware configuration example of the terminal apparatus 10 according to the embodiment will be described.

As illustrated in FIG. 2, the terminal apparatus 10 includes a system-on-chip (SoC) 3, a camera 51, an SDRAM 52, a flash memory 53, a Wi-Fi controller 54, and an LCD 15. Note that, the terminal apparatus 10 as an input/output (I/O) device may include a mic that acquires (records) audio data, a speaker that outputs the audio data, and an input device such as a touch panel mounted on the LCD 15 or a keyboard (all not illustrated).

The camera 51 is an imaging device that photographs the still image or the moving image and converts the photographed still image or moving image into an electric signal, and outputs the electric signal to the SoC 3 as the content.

The SDRAM (memory) 52 is one example of a volatile memory as a storage device that temporarily stores various data or programs. The SDRAM 52 temporarily stores and deploys, and uses data or programs when the CPU 32 executes the program. Further, the SDRAM 52 temporarily holds the content photographed by the camera 51.

The flash memory (storage unit) 53 is an example of a nonvolatile memory that stores a content which is photographed by the camera 51 and subjected to predetermined processing by the SoC 3.

The Wi-Fi controller 54 is a controller that transmits and receives data to/from the display device 20 by the Wi-Fi communication and is an example of the transmitter 17 illustrated in FIG. 1.

The SoC (integrated circuit) 3 includes an L3 interconnect 31, a CPU 32, an imaging processor 33, a GPU 34, a DC 35, an H.264 encoder 36, an NAND controller 37, and an EMAC 38.

The L3 interconnect 31 is an interface that connects circuit blocks on the SoC 3 and has a data transmission speed which is highest among other interconnects and buses in the SoC 3. Respective blocks of reference numerals 16 and 32 to 38 illustrated in FIG. 2, and the SDRAM 52 are connected to each other via the L3 interconnect 31.

The CPU 32 is one example of a processor that implements various functions by executing a program stored in the SDRAM 52 or a read only memory (ROM) (not illustrated). Note that, an MPU may be used as the first to third examples to be described below, instead of the CPU 32.

The imaging processor 33 is a processor that executes predetermined processing such as noise correction or filter processing of the content photographed by the camera 51 to hold the executed processing in the SDRAM 52.

The GPU 34 is a processor that executes drawing processing of the content held by the SDRAM 52 for displaying the content on the LCD 15. Further, the DC 35 is a controller that outputs the content subjected to the drawing processing by the GPU 34 to the LCD 15. Note that, the GPU 34 and the DC 35 are examples of the display processing unit 14 illustrated in FIG. 1.

The H.264 encoder (second encoder) 36 is an encoder that executes H.264 format encode (compression) processing for storing the content of the moving image held by the SDRAM 52 in the flash memory 53 and stores the encoded content in the flash memory 53.

The NAND controller 37 is a controller that controls writing and reading in and from the flash memory 53 and stores the content encoded by the H.264 encoder 36 in the flash memory 53.

The M-JPEG encoder (first encoder) 16 is one example of the encoder 16 illustrated in FIG. 1 and performs the M-JPEG format encoding of the content subjected to the display processing by the DC 35. Note that, the encode processing by the M-JPEG encoder 16 is encode processing which is higher than the encode processing by the H.264 encoder 36 in compression rate.

The EMAC 38 is a controller that controls transmission/reception between the CPU 32 and the Ethernet network, and controls transmission/reception between the CPU 32 and the Wi-Fi network through the Wi-Fi controller 54 in the example illustrated in FIG. 2.

Note that, the LCD 15 displays the content subjected to the display processing by the GPU 34 and the DC 35 and is one example of the display unit 15 illustrated in FIG. 1.

### [1-3] Operating Example of Embodiment

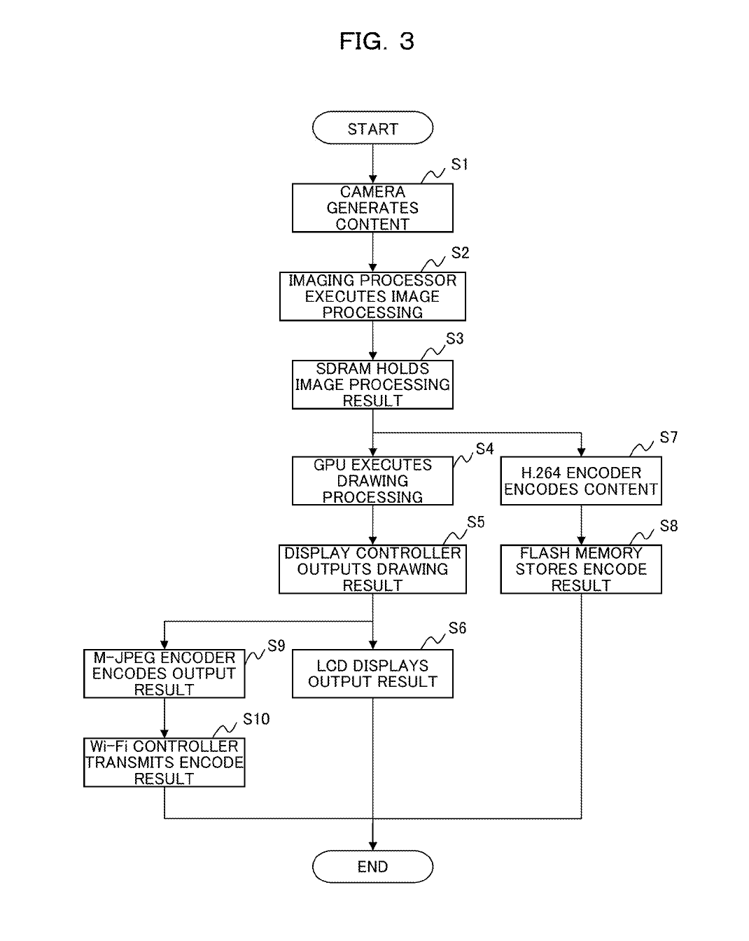

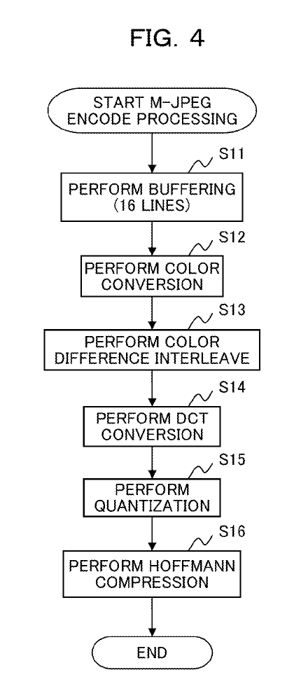

Next, the operating example of the terminal apparatus 10 configured as described above will be described with reference to FIGS. 3 and 4. FIG. 3 is a flowchart describing operating examples of display processing, storage processing, and transmission processing of the content by the terminal apparatus 10 illustrated in FIG. 2. FIG. 4 is a flowchart describing an operating example of the encode processing by the M-JPEG encoder 16 illustrated in FIG. 2.

Note that, in FIG. 3, the content of the moving image (movie) is photographed by the camera 51.

### [1-3-1] Operating Example of Communication System

First, the operating example of the terminal apparatus 10 will be described.

As illustrated in FIG. 3, when the camera 51 photographs (generates) the content (step S1), the imaging processor 33 executes image processing of the content (step S2) and holds an image processing result in the SDRAM 52 (step S3).

Subsequently, the GPU 34 executes drawing processing of the content held by the SDRAM 52 (step S4) and the DC 35 outputs a drawing result to the LCD 15 (step S5). In addition, the LCD 15 displays an output result (step S6) and the display processing is completed.

On the other hand, the H.264 encoder 36 executes encoding of the H.264 format for the content held by the SDRAM 52 (step S7), and an encoding result is held by the flash memory 53 (step S8), and the storage processing is completed.

Further, the M-JPEG encoder 16 executes the M-JPEG format encode for a drawing result adjusted for the LCD 15 to be output to the LCD 15 by the DC 35, that is, the content subjected to the display processing (step S9). In addition, the Wi-Fi controller 54 transmits the encode result to the display device 20 via the Wi-Fi communication 1a (step S10) and transmission processing is completed.

Note that, since FIG. 3 illustrates processing for one frame in the terminal apparatus 10, the terminal apparatus 10 performs processing illustrated in FIG. 3 for all frames of the content. As such, the operation is executed for each frame of the generated content, and as a result, the terminal apparatus 10 performs display processing of the content on the LCD 15, storage processing in the flash memory 53, and transmission processing (screen mirroring) to the display device 20.

### [1-3-2] Operating Example of M-JPEG Encoder

Next, the operating example of the M-JPEG encoder 16 will be described.

As illustrated in FIG. 4, the M-JPEG encoder 16 performs buffering for 16 lines of the content subjected to the display processing by the DC 35, for example, in order to perform processing for each of 16 lines (step S11). Note that, the buffering is performed by using a register of the M-JPEG encoder 16 (not illustrated).

Subsequently, the M-JPEG encoder 16 converts the content for 16 lines from an RGB system to a color space by YCbCr (step S12). In addition, the M-JPEG encoder 16 interleaves the number of bits or the number of pixels based on a color difference with respect to the content subjected to the color conversion (step S13) and performs conversion to a frequency area by discrete cosine transform (DCT) (step S14).

Further, the M-JPEG encoder 16 quantizes the conversion result by the DCT and interleaves a high-frequency bit number (step S15). In addition, the M-JPEG encoder 16 performs Hoffman compression (step S16) and processing of buffered data is completed.

Note that, since FIG. 4 illustrates processing of the buffered data in one frame, the M-JPEG encoder 16 executes the processing illustrated in FIG. 4 with respect to all lines of one frame in the content subjected to the display processing by the DC 35. In addition, the M-JPEG encoder 16 execute encode processing for one frame with respect to all frames of the content subjected to the display processing by the DC 35, and as a result, the encode processing for transmitting the content to the display device 20 is completed. Note that, in the M-JPEG format encode, since independent encode is performed for each frame of the content, the M-JPEG encoder 16 may not consider a difference between frames, or the like. As a result, high-speed encode processing may be implemented.

As described above, the encoder 16 of the terminal apparatus 10 according to the embodiment executes encode processing for transmitting the content subjected to the display processing by the display processing unit 14 to the display device 20. That is, the output from the display processing unit 14 in the terminal apparatus 10 as the mirroring source is compressed by the encoder 16. Further, the transmitter 17 transmits the compressed output to the display device 20 as the mirroring destination via the wireless LAN (Wi-Fi communication 1a).

As a result, the terminal apparatus 10 may implement screen mirroring by wireless LAN connection and improve convenience when displaying the content displayed in the terminal apparatus 10 on the receiving device 20.

Further, the display processing unit 14 (the GPU 34 and the DC 35) and the encoder 16 are installed in the SoC 3 and are connected with each other by the existing L3 interconnect 31. As a result, addition of a new high-speed bus for connecting the integrated circuits (ICs) (for example, an interface including a transmission speed based on the L3 interconnect) for the encoder 16 may be omitted. As such, the terminal apparatus 10 according to the embodiment is implemented by performing addition of a communication channel depending on the screen mirroring in the SoC 3, and addition of the encoder 16 and a change of connection to the SoC 3. As a result, a load of the MPU 32 may be suppressed, and an increase of power consumption, an increase in difficulty of substrate design, and cost-up may be minimized as compared with screen mirroring using a VNC technology.

Further, the content subjected to the display processing by the display processing unit 14 is just originally output to the display unit 15. In this regard, the terminal apparatus 10 according to the embodiment allows the encoder 16 to execute encode of a content of which optimal adjustment for displaying on the display unit 15 is already performed to provide an excellent content to the display device 20. In particular, in the case where the display unit 15 of the terminal apparatus 10 and the display unit 25 of the display device 20 include the equivalent performance, the terminal apparatus 10 may provide the content of which the optimal adjustment is performed for the display device 20 and reduce processing load of the display processing unit 24 or the like.

Further, according to the terminal apparatus 10, even the problems of (i) to (iv) which may occur when performing the screen mirroring by using the VNC technology may be resolved by reasons described in (I) to (IV) below.

(I) In the M-JPEG format encode processing, since the entirety of the screen is output for each frame, a display failure including a block shape does not occur on the screen displayed in the display device 20.

(II) In the M-JPEG format encode processing, a delay of approximately 2 to 3 frames just stably occurs, and a delay amount and a delay width are small.

(III) In the M-JPEG format encode processing, contents of high-resolution moving images may be consecutively output at 30 fps and are not output by skipping operation at several to dozens of frames like VNC.

(IV) The terminal apparatus 10 executes most processing depending on the content transmitted to the display device 20 by an exclusive encoder 16. That is, since the terminal apparatus 10 executes processing (primarily, encode processing) for transmitting the content to the display device 20 to be partially or completely separated from the operations of the application 11 and the OS, there is a small influence that exerts on the operations of the application 11 and the OS.

As such, the terminal apparatus 10 may implement the screen mirroring of the content of the high-resolution moving image which was difficult in the VNC technology by the wireless LAN connection.

### [2] Example of Embodiment

Next, an installation example of the encoder 16 (M-JPEG encoder 16) of the terminal apparatus 10 (10a to 10c) in the communication system 1 according to the embodiment will be described.

The encoder 16 may be implemented by configurations (1) to (3) described below.

(1) Software encode format

(2) Time division encode format of hardware accelerator

(3) Addition of hardware encoder format

Hereinafter, the communication system 1 adopting the configuration (1) to (3) will be described in accordance with first to third examples.

Note that, hereinafter, it will be assumed that the terminal apparatus 10 (10a to 10c) performs respective operations of photographing of a movie and storage of the content by the camera 51 which has a large processing load to the MPU 32, display (screen preview) of the content by the display unit 15, and a screen mirroring output by the wireless LAN.

### [2-1] First Example

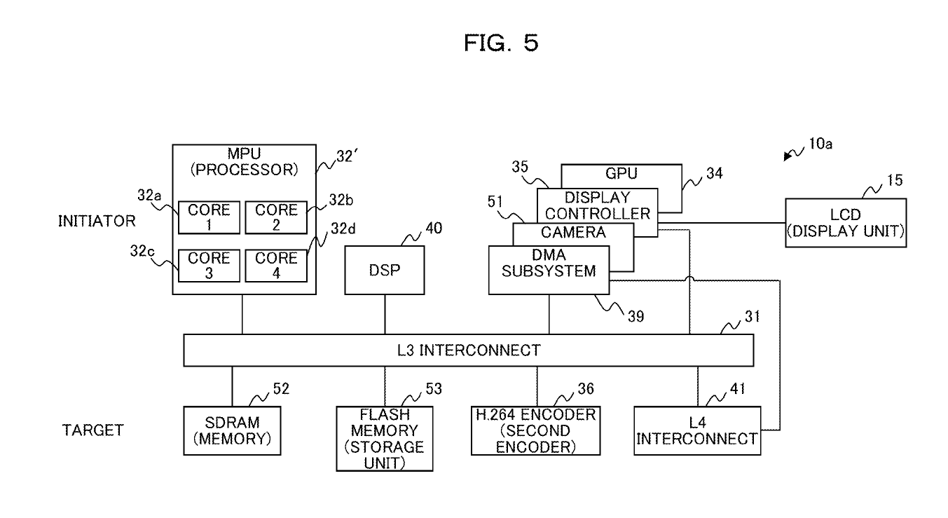

First, a first example will be described with reference to FIGS. 5 to 10. In the first example, the encoder 16 is configured by a software encoder of the (1) described above.

### [2-1-1] Configuration Example of Terminal Apparatus of First Example

First, a configuration example of a terminal apparatus 10a according to the first example will be described as an example.

FIG. 5 is a diagram illustrating a hardware configuration example of the terminal apparatus 10a according to the first example. As illustrated in FIG. 5, the terminal apparatus 10a includes a direct memory access (DMA) subsystem 39, a digital signal processor (DSP) 40, and an L4 interconnect 41, in addition to the configuration of the terminal apparatus 10 illustrated in FIG. 2. Note that, in FIG. 5, some blocks of the terminal apparatus 10 illustrated in FIG. 2 are not illustrated, for convenience.

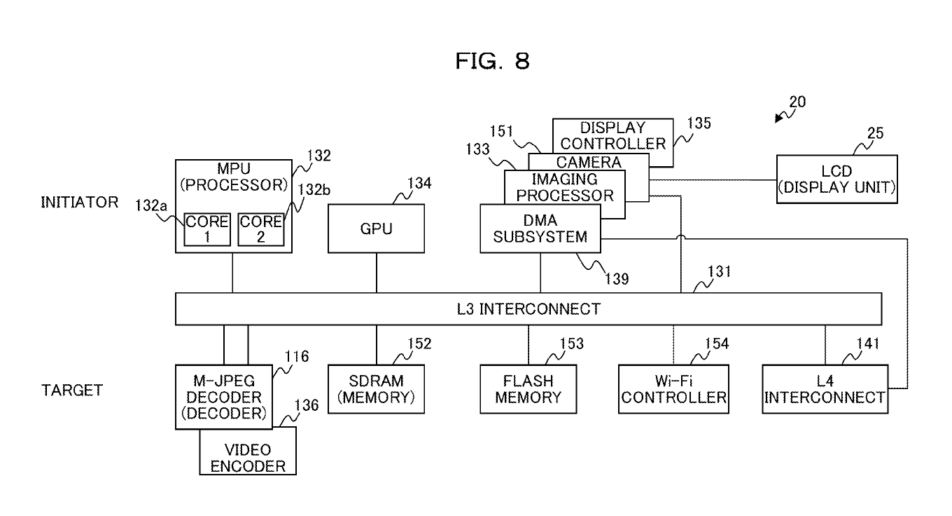

Further, in FIG. 5, each block connected to a lower side of a paper plane of the L3 interconnect 31 is an access target or a target that is controlled to execute an predetermined operation and each block connected to an upper side of the paper plane is an initiator that controls the target. Note that, the same is applied to even each hardware configuration (see FIGS. 8, 11, and 16) of the display device 20 and the terminal apparatuses 10b and 10c to be described below.

The DMA subsystem 39 is connected to the L3 interconnect 31 and controls transmission of data between the SDRAM 52 and other blocks. For example, the DMA subsystem 39 controls writing and reading of the content in and from the SDRAM 52 by the GPU 34, the DC 35, and the camera 51 (imaging processor 33), and the like.

The DSP 40 is a processor that executes compression processing of audio data held in the SDRAM 52 and holds the compressed audio data in the SDRAM 52. Note that, the audio data compressed by the DSP 40 is acquired (recorded) by a mic (not illustrated) as an I/O device, and is stored in the SDRAM 52.

The L4 interconnect 41 is an interface that connects the circuit blocks on the SoC 3 to each other and has a lower data transmission speed than the L3 interconnect. In the example illustrated in FIG. 5, the L4 interconnect 41 is connected with the L3 interconnect 31 and the DMA subsystem 39. Further, the L4 interconnect 41 are connected with I/O devices in the case where the terminal apparatus 10 includes the I/O devices.

Further, as illustrated in FIG. 5, the terminal apparatus 10a includes an MPU 32′ instead of the CPU 32 of the terminal apparatus 10 illustrated in FIG. 2.

The MPU 32′ includes a plurality of, for example, four cores 32a to 32d. The respective cores 32a to 32d may independently execute processing. The MPU 32′ according to the first example executes a processing program stored in the SDRAM 52, or the like with respect to at least one of the plurality of cores 32a to 32d to implement the function as the M-JPEG encoder 16.

For example, the terminal apparatus 10a according to the first example determines allocation of the cores 32a to 32d in advance as described below.

Core 32a: Main processing of the application 11 and OS processing

Core 32b: Imaging/video processing

Core 32c+32d: Software encode processing

As such, processing is allocated to the respective four cores 32a to 32d, and as a result, the MPU 32′ may execute the encode processing as the M-JPEG encoder 16 to be partially separated from the main processing and OS processing of the application 11. Therefore, even in the case where the cores 32c and 32d execute the software encode processing, the influence which is exerted on the operations of the application 11 and the OS may be slightly suppressed.

Note that, in order to implement the software encode processing by the MPU 32′, the terminal apparatus 10a has a path of returning the execution result (output) of the display processing from the DC 35 to the L3 interconnect 31, as illustrated in FIG. 5. In addition, the output from the DC 35 to the L3 interconnect 31 is once stored in the SDRAM 52. Further, the MPU 32′ reads the execution result output of the display processing from the SDRAM 52 to execute the software encode processing by the cores 32c and 32d.

### [2-1-2] Operating Example of Terminal Apparatus of First Example

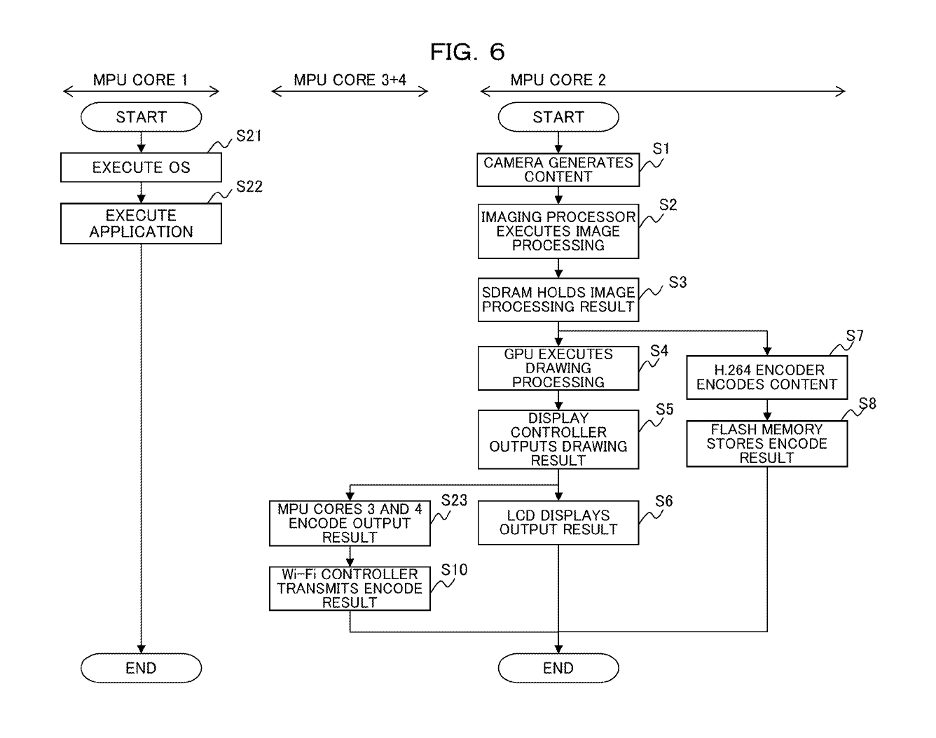

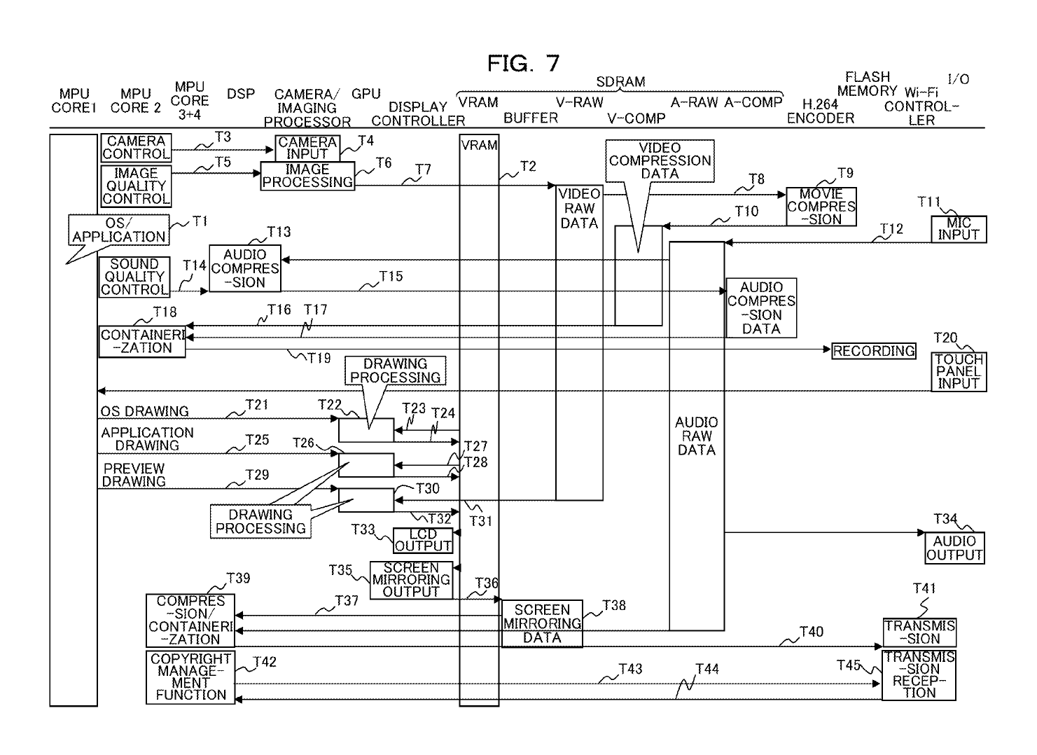

Next, the operating example of the terminal apparatus 10a configured as described above will be described with reference to FIGS. 6 and 7. FIGS. 6 and 7 are a flowchart and a sequence diagram describing operating examples of display processing, storage processing, and transmission processing of the content by the terminal apparatus 10a illustrated in FIG. 5.

Note that, in FIGS. 6 and 7, the content of the movie (video) is photographed (generated) by the camera 51 and a content of audio is acquired (generated) by a mic of an I/O device (not illustrated).

Note that, in the description of FIG. 6, since the same reference numerals as the reference numerals illustrated in FIG. 3 refer to the same or substantially the same processing, a detailed description thereof is omitted. Hereinafter, this will be described to correspond to FIG. 6 in accordance with the sequence diagram of FIG. 7. In addition, hereinafter, in the descriptions of FIGS. 6 and 7, the cores 32a to 32d may be called core 1 to core 4.

As illustrated in FIG. 7, the OS and the application 11 are executed in the core 1 of the MPU 32′ (processing T1, and steps S21 and S22 of FIG. 6). Further, a video RAM (VRAM) which is an area for video display of the SDRAM 52 is secured for display processing by a GPU 34 and a DC 35 to be described below (processing T2).

Further, when the core 2 of the MPU 32′ instructs controlling the camera 51 (processing T3), the camera 51 is actuated and the photographed (generated) content is input, by the imaging processor 33 (processing T4, and step S1 of FIG. 6). Further, the core 2 of the MPU 32′ instructs image control (processing T5) and the imaging processor 33 performs image processing of the input content (processing T6, and step S2 of FIG. 6).

Subsequently, the imaging processor 33 (DMA subsystem 39) stores the image processing result in a V-RAW area of the SDRAM 52 as video RAW data (processing T7, and step S3 of FIG. 6). Further, the video RAW data is transmitted to the H.264 encoder (video encoder) 36 (processing T8) and H.264 format movie compression (encode processing) is performed by the H.264 encoder 36 (processing T9, and step S7 of FIG. 6). In addition, the H.264 encoder 36 stores the movie-compressed content in a V-COMP area of the SDRAM 52 as the video compression data (processing T10).

Further, the audio data is acquired by the mic of the I/O device (processing T11) and stored in an A-RAW area of the SDRAM 52 as the audio RAW data (processing T12). In addition, the DSP 40 executes audio compression processing of the audio RAW data (processing T13). Note that, the DSP 40 executes the audio compression processing by receiving an instruction (processing T14) of controlling sound quality by the core 2 of the MPU 32′ and stores the compression result in the A-COMP area of the SDRAM 52 as the audio compression data (processing T15).

Subsequently, the core 2 of the MPU 32′ acquires the video compression data and the audio compression data from the SDRAM 52 (processing T16 and T17), and the respective compression data are collected to be containerized (processing T18). In addition, the core 2 transmits the containerized content to the NAND controller 37 and records the transmitted content in the flash memory 53 (processing T19, and step S8 of FIG. 6).

By the configuration, the moving photographing and the storage processing of the content by the camera 51 are completed in the terminal apparatus 10a.

On the other hand, with the processing of processing T8, displaying (screen previewing) of the content on the LCD 15 is required to the application 11 by a touch panel of the I/O device (processing T20). When the screen previewing is requested, the core 1 of the MPU 32′ instructs OS drawing (processing T21) and the GPU 34 executes drawing processing of the screen of the OS on the LCD 15 (processing T22). In this case, when the data of the screen of the OS is held in the VRAM area, the GPU 34 uses the data of the screen for the drawing processing (processing T23). When the OS drawing processing is completed, the GPU 34 writes the result in the VRAM area (processing T24).

Subsequently, the core 1 of the MPU 32′ instructs application drawing (processing T25) and the GPU 34 executes drawing processing of the screen of the application 11 to the LCD 15 similarly to the drawing of the screen of the OS (processing T26). In this case, when the data of the screen of the application 11 is held in the VRAM area, the GPU 34 uses the data of the screen for the drawing processing (processing T27). When the application drawing processing is completed, the GPU 34 (DMA subsystem 39) writes the result in the VRAM area (processing T28).

Further, the core 1 of the MPU 32′ instructs preview drawing (processing T29) and the GPU 34 executes drawing processing of the preview screen of the content designated by the application 11 on the LCD 15 (processing T30). In this case, the GPU 34 reads the video RAW data from the V-RAW area and uses the read video RAW data for the drawing processing (processing T31). When the preview drawing processing is completed, the GPU 34 (DMA subsystem 39) writes the result in the VRAM area (processing T32, and step S4 of FIG. 6).

When the result of each drawing processing of the processing T24, T28, and T32 is written in the VRAM area, the DC 35 outputs the drawing result to the LCD 15 from the VRAM area at a timing of the screen output (processing T33, and step S5 of FIG. 6), and the output result is displayed by the LCD 15 (step S6 of FIG. 6). Further, the audio RAW data of the A-RAW area of the SDRAM 52 is output by a speaker of the I/O device (processing T34).

By this configuration, displaying the content by the LCD 15 is completed in the terminal apparatus 10a.

Further, the DC 35 screen mirroring-outputs the drawing result from the VRAM area (processing T35) and the DMA subsystem 39 writes the drawing result in the buffer area of the SDRAM 52 as the screen mirroring data (processing T36). Note that, the DC 35 may output contents including different resolutions in processing T33 and T35, respectively. For example, the DC 35 may screen mirroring-output with resolution suitable for the display unit 25 of the display device 20. On the other hand, in the case where the DC 35 outputs the same content in processing T33 and T35, processing T35 may be omitted and the output of processing T33 may be branched for screen mirroring.

Further, the cores 3 and 4 of the MPU 32′ read the screen mirroring data from the buffer area (processing T37) and read the audio RAW data from the A-RAW area (processing T38).

The cores 3 and 4 of the MPU 32′ execute M-JPEG format compression (encode processing) with respect to the input screen mirroring output and containerize the compressed output together with the audio RAW data and a control signal (processing T39, and step S23 of FIG. 6). Further, the cores 3 and 4 transmit the containerized content to the EMAC 38 (processing T40) and the Wi-Fi controller 54 transmits the transmitted content to the display device 20 (processing T41, and step S10 of FIG. 6).

Note that, the cores 3 and 4 may execute a copyright management function (processing T42), and information such as a key used in encoding may be transmitted to/received from the display device 20 via the Wi-Fi communication 1a (processing T43 to T45).

By the above configuration, a screen mirroring output by the wireless LAN is completed in the terminal apparatus 10a.

Note that, since FIGS. 6 and 7 illustrate processing for one frame in the terminal apparatus 10, the terminal apparatus 10 performs the processing illustrated in FIGS. 6 and 7 for all frames of the content. As such, the operation is executed for each frame of the generated content, and as a result, the terminal apparatus 10 performs display processing of the content to the LCD 15, storage processing in the flash memory 53, and transmission processing (screen mirroring) to the display device 20.

As described above, the terminal apparatus 10a according to the first example may achieve the same effect as the terminal apparatus 10 according to the embodiment.

### [2-1-3] Configuration Example of Display Device of First Example

Next, a configuration example of the display device 20 according to the first example will be described.

FIG. 8 is a diagram illustrating a hardware configuration example of the display device 20 according to the first example. Note that, a configuration of the display device 20 illustrated in FIG. 8 is common with the display device 20 according to the embodiment illustrated in FIG. 1 and display devices 20 according to second and third examples to be described below. Therefore, in the following description, a transmission source of the content depending on the screen mirroring is not limited to the terminal apparatus 10a and may be the terminal apparatus 10.

As illustrated in FIG. 8, the display device 20 includes an L3 interconnect 131, an MPU 132, an imaging processor 133, a GPU 134, a DC 135, and a video encoder 136, each of which installed in an SoC (not illustrated). Further, the display device 20 includes a DMA subsystem 139, an L4 interconnect 141, and an M-JPEG decoder 116, each of which installed in the SoC (not illustrated). In addition, the display device 20 includes a camera 151, an SDRAM 152, a flash memory 153, a Wi-Fi controller 154, and an LCD 25. Note that, the display device 20 may include a speaker (not illustrated) as an I/O device that outputs audio data.

Since each block illustrated in FIG. 8 basically has the same function as each block including the same name in the terminal apparatuses illustrated in FIGS. 2 and 5, a duplicated description is omitted. That is, the L3 interconnect 131, the MPU 132, the imaging processor 133, the GPU 134, and the DC 135 include the same function as the L3 interconnect 31, the MPU 32, the imaging processor 33, the GPU 34, and the DC 35 of the terminal apparatus 10, respectively. Further, the video encoder 136, the DMA subsystem 139, and the L4 interconnect 141 include the same functions as the video encoder 36, the DMA subsystem 39, and the L4 interconnect 41 of the terminal apparatus 10, respectively. In addition, the camera 151, the SDRAM 152, the flash memory 153, the Wi-Fi controller 154, and the LCD 25 include the same functions as the camera 51, the SDRAM 52, the flash memory 53, the Wi-Fi controller 54, and the LCD 15 of the terminal apparatus 10, respectively. Note that, in FIG. 8, some blocks are not illustrated, for convenience, similarly to the terminal apparatus 10a illustrated in FIG. 5.

Hereinafter, a difference from the terminal apparatus 10 in each block of the display device 20 will be described.

The MPU 132 includes a plurality of, for example, two cores 132a and 132b. The respective cores 132a and 132b may independently execute processing. For example, the display device 20 according to the first example determines allocation of the cores 132a and 132b as described below in advance.

Core 132a: Main processing of the application 21 and OS processing

Core 132b: Imaging/video processing

The M-JPEG decoder 116 executes M-JPEG format decode (extension) processing of the content received from the terminal apparatus 10 through the Wi-Fi communication 1a by the Wi-Fi controller 154.

Note that, decoding of the content and displaying the content on the LCD 25 by the display device 20 may be performed similarly to decoding and displaying an Internet moving image in a mobile terminal, or the like.

### [2-1-4] Operating Example of Display Device of First Example

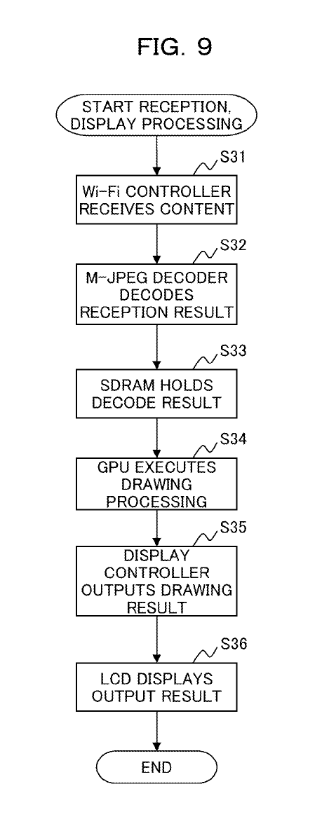

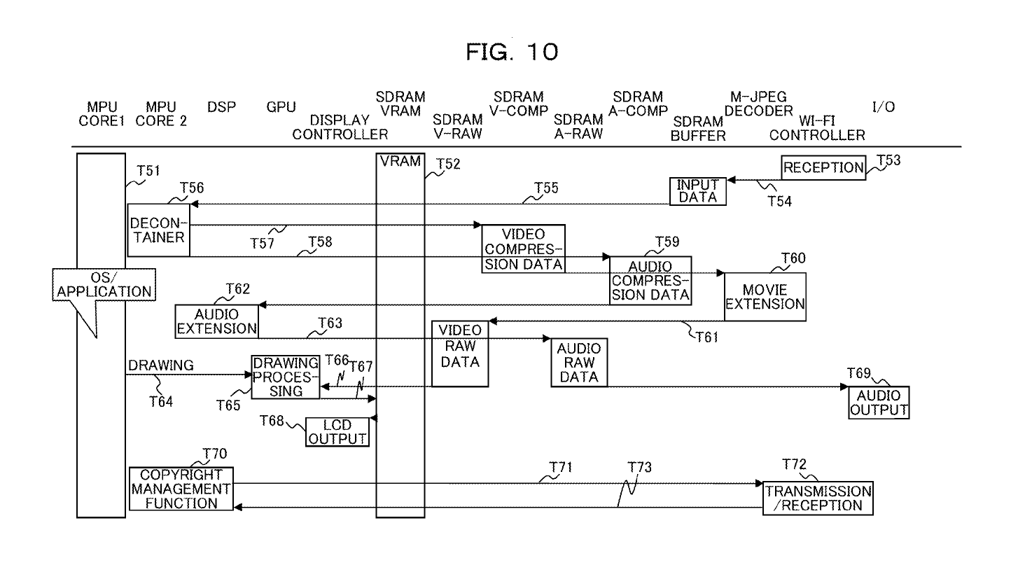

Next, the operating example of the display device 20 configured as described above will be described with reference to FIGS. 9 and 10. FIGS. 9 and 10 are a flowchart and a sequence diagram describing reception processing and display processing of a content by the display device 20 illustrated in FIG. 8.

Note that, FIGS. 9 and 10 illustrate processing for one frame in the display device 20. Further, in FIGS. 9 and 10, a case in which the content subjected to the M-JPEG format encode processing is received as a content including a movie and an audio from the terminal apparatus 10 is illustrated.

Hereinafter, this will be described to correspond to FIG. 9 in accordance with the sequence diagram of FIG. 10. Further, hereinafter, in the descriptions of FIGS. 9 and 10, the cores 132a and 132b may be called the cores 1 and 2.

As illustrated in FIG. 10, the core 1 of the MPU 132 executes an OS and application 21 (processing T51). Further, the VRAM area of the SDRAM 152 is secured for the display processing by the GPU 134 and the DC 135 to be described below (processing T52).

Herein, when the Wi-Fi controller 154 (and EMAC (not illustrated)) receives the content from the terminal apparatus 10 (processing T53, and step S31 of FIG. 9), the content is buffered in the buffer area of the SDRAM 152 (processing T54). The content held in the buffer area is read by the core 2 of the MPU 132 (processing T55) and decontainerized (processing T56). In the decontainerizing, the core 2 stores the content separated from the video compression data and the audio compression data in the V-COMP area and the A-COMP area of the SDRAM 52, respectively (processing T57 and T58).

Subsequently, the DMA subsystem 139 transmits the video compression data stored in the V-COMP area to the M-JPEG decoder 116 (processing T59). In addition, the M-JPEG decoder 116 performs movie-extension (decode processing) of the video compression data (processing T60, and step S32 of FIG. 9) and stores the video compression data in the V-RAW area of the SDRAM 52 (processing T61, and step S33 of FIG. 9). On the other hand, the audio compression data stored in the A-COMP area is audio-extended by the DSP 140 (processing T62) and stored in the A-RAW area of the SDRAM 52 (processing T63).

Further, the core 1 of the MPU 132 instructs drawing (processing T64) and the GPU 134 executes drawing processing of the content designated by the application 11 on the LCD 25 (processing T65). In this case, the GPU 134 reads the video RAW data from the V-RAW area and uses the read video RAW data for the drawing processing (processing T66). When the drawing processing is completed, the GPU 134 writes the result in the VRAM area (processing T67, and step S34 of FIG. 9).

When the result of the drawing processing is written in the VRAM area, the DC 135 outputs the drawing result to the LCD 25 from the VRAM area at a timing of the screen output (processing T68, and step S35 of FIG. 9), and the output result is displayed by the LCD 25 (step S36 of FIG. 9). Further, the audio RAW data of the A-RAW area is output by the speaker of the I/O device (processing T69).

Note that, the core 2 may execute the copyright management function (processing T70), and the information such as the key used in encoding may be transmitted to/received from the terminal apparatus 10 via the Wi-Fi communication 1a (processing T71 to T73).

By the above configuration, in the display device 20, receiving the content and displaying the received content by the LCD 25 are completed.

Note that, since FIGS. 9 and 10 illustrate processing for one frame in the display device 20, the display device 20 performs the processing illustrated in FIGS. 9 and 10 for all frames of the content. As such, the operation is executed for each frame of the received content, and as a result, reception processing of the content and display processing of the received content on the LCD 25 are performed in the display device 20.

### [2-2] Second Example

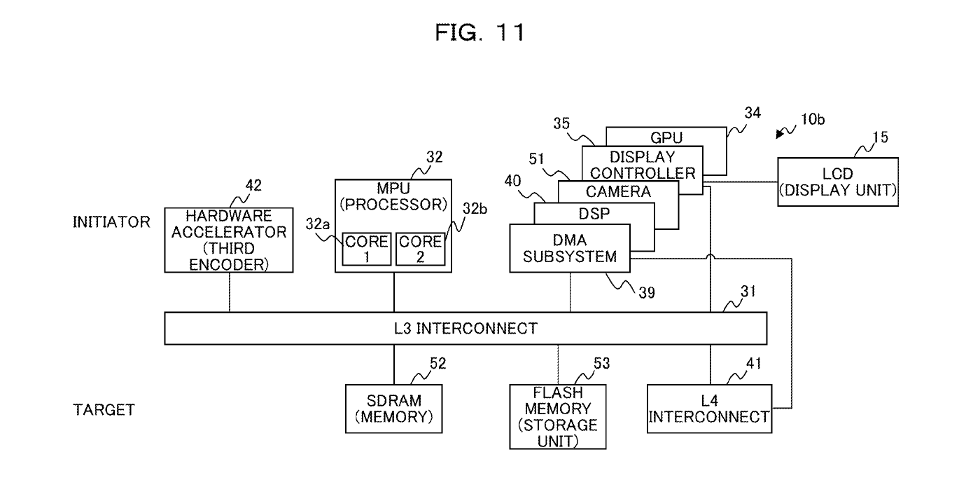

Next, a second example will be described with reference to FIGS. 11 to 15. In the second example, the encoder 16 is configured by a hardware accelerator of (2) described above.

### [2-2-1] Configuration Example of Terminal Apparatus of Second Example

First, a configuration example of a terminal apparatus 10b according to the second example will be described.

FIG. 11 is a diagram illustrating the hardware configuration example of the terminal apparatus 10b according to the second example. As illustrated in FIG. 11, the terminal apparatus 10b includes a DMA subsystem 39, a DSP 40, an L4 interconnect 41, and a hardware accelerator 42, in addition to the configuration of the terminal apparatus 10 illustrated in FIG. 2. Note that, in FIG. 11, some blocks of the terminal apparatus 10 illustrated in FIG. 2 are not illustrated, for convenience.

Note that, since the DMA subsystem 39, the DSP 40, and the L4 interconnect 41 include the same reference numerals as those illustrated in FIG. 5, a detailed description thereof is omitted.

The MPU 32 includes a plurality of, for example, two cores 32a and 32b. The respective cores 32a and 32b may independently execute processing. For example, the terminal apparatus 10b according to the second example determines allocation of the cores 32a and 32b as described below in advance.

Core 32a: Main processing of the application 11 and OS processing

Core 32b: Imaging/video processing

The hardware accelerator (third encoder) 42 is hardware additionally installed in the processor such as the MPU 32. In detail, the hardware accelerator 42 may execute the M-JPEG format encode processing executed by the M-JPEG encoder 16 and the H.264 format encode processing executed by the H.264 encoder 36 illustrated in FIG. 2 in time division. As a result, installation of the M-JPEG encoder 16 and the H.264 encoder 36 may be omitted in the terminal apparatus 10b.

That is, in the terminal apparatus 10b according to the second example, the M-JPEG encoder 16 and the H.264 encoder 36 illustrated in FIG. 2 are configured by the hardware accelerator 42 as one common encoder.

Note that, in order to implement the encode processing by the hardware accelerator 42, the terminal apparatus 10b has a path returning the execution result (output) of the display processing from the DC 35 to the L3 interconnect 31, as illustrated in FIG. 11. In addition, the output from the DC 35 to the L3 interconnect 31 is once stored in the SDRAM 52. Further, the hardware accelerator 42 switches and executes the H.264 format encode processing for the movie and the M-JPEG format encode processing for the screen mirroring for each frame time (for example, 1/30s) (in time division).

Herein, the video encoder (hardware accelerator) uses only a fixed encode format, or takes a time to perform encode-mode switching processing when the video encoder (hardware accelerator) changes a lot of setting registers or reloads software. Therefore, the hardware accelerator 42 according to the second example enables interrupt during processing of encoding (for example, H.264 format) suitable for the movie and enables processing of the other encode mode (for example, M-JPEG format) suitable for mirroring while holding an immediately previous status.

Since the hardware accelerator 42 performs processing by referring to previous and subsequent frames in the encode suitable for the movie, the hardware accelerator 42 has an interframe comparison function. On the other hand, since the hardware accelerator 42 processes a single frame in the encode suitable for the mirroring, the interframe comparison function may be omitted. As such, since functioning units executed between both encodes suitable for the movie and suitable for the mirroring are different from each other, the hardware accelerator 42 preferably additionally includes a mechanism that unloads only statuses of some functioning units which are common between both types.

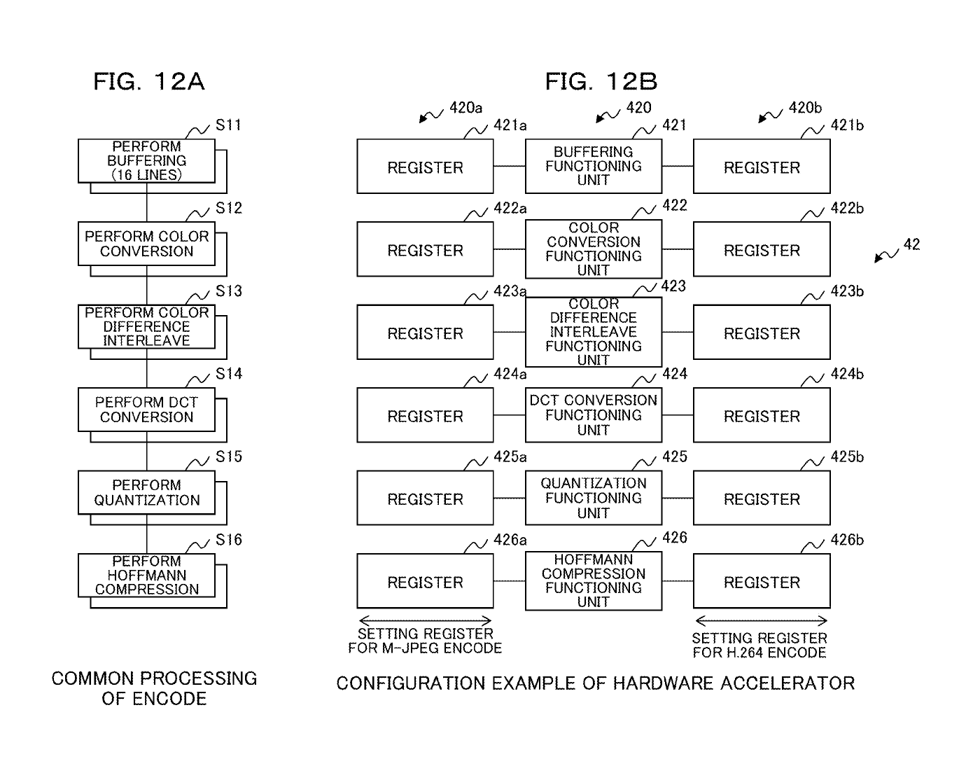

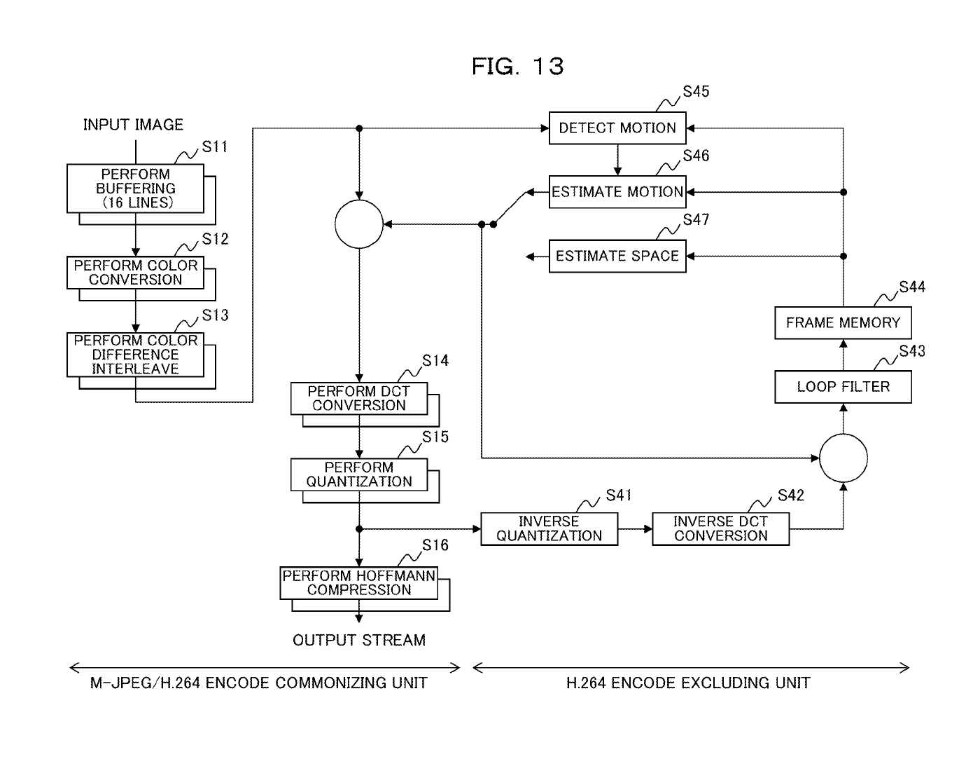

Herein, the function of the encode processing illustrated in FIG. 4 is common in the H.264 format encode suitable for the movie and the M-JPEG format encode suitable for the mirroring. Therefore, the hardware accelerator 42 is configured to unload the function which is common between both types, as illustrated in FIGS. 12A, 12B, and 13.

FIG. 12A is a diagram illustrating an example of common processing of encode by the hardware accelerator 42 illustrated in FIG. 11, FIG. 12B is a diagram illustrating a configuration example of the hardware accelerator 42 illustrated in FIG. 11, and FIG. 13 is a flowchart describing an operating example of encode processing by the hardware accelerator 42.

As illustrated in FIG. 12B, the hardware accelerator 42 includes an encode processing unit 420, a first register 420a, and a second register 420b.

The encode processing unit 420 at least executes common processing of the both encode types illustrated in FIG. 12A. The encode processing unit 420 includes a buffering functioning unit 421, a color conversion functioning unit 422, a color difference interleave functioning unit 423, a DCT conversion functioning unit 424, a quantization functioning unit 425, and a Hoffman compression functioning unit 426.

The buffering functioning unit 421, for example, performs buffering for 16 lines for a content to be encoded. The color conversion functioning unit 422 performs conversion into a color space depending on the encode type for the content for 16 lines. The color difference interleave functioning unit 423 performs interleaving of the number of bits or the number of pixels based on a color difference for the content subjected to the color conversion. The DCT conversion functioning unit 424 converts the content subjected to the color difference interleaving into a frequency area. The quantization functioning unit 425 quantizes a transformation result by the DCT and performs interleaving of the number of high-frequency bits. The Hoffman compression functioning unit 426 performs Hoffman compression of the quantized content.

The first register 420a is a setting register that holds status information used when each of the functioning units 421 to 426 performs, for example, the M-JPEG type encode, and includes registers 421a to 426a corresponding to the respective functioning units 421 to 426.

The second register 420a is a setting register that holds status information used when each of the functioning units 421 to 426 performs, for example, the H.264 type encode, and includes registers 421b to 426b corresponding to the respective functioning units 421 to 426.

Note that, in a time-division encode, the hardware accelerator 42 performs locking so as to prevent the other type encode from being executed while executing one type encode. The locking is released at a time-division switching timing or when the encode by one type is completed.

By the above configuration, the hardware accelerator 42 executes processing illustrated in FIG. 13. Note that, in the processing illustrated in FIG. 13, processing executed by the M-JPEG format encode includes steps S11 to S16 (see FIG. 4). The encode processing unit 420 performs setting for the executed encode with respect to the first register 420a or the second register 420b, and executes only requested processing at the time of performing only any one format encode of the M-JPEG format and the H.264 format.

On the other hand, in the case where the encode processing unit 420 performs processing with both type encodes in time division, the encode processing unit 420 executes encode processing while switching the first register 420a and the second register 420b for each encode. As a result, the encode processing unit 420 may reduce overhead (time) depending on switching of the encode formats.

Hereinafter, a detailed example of the time-division encode by the hardware accelerator 42 will be described.

First, in the case where the M-JPEG format encode is performed, the encode processing unit 420 executes processing of steps S11 to S16 for an input image by using the registers 421a to 426a and outputs an output stream, as illustrated in FIG. 13. Herein, when the time-division switching timing (for example, the frame time) is reached, the encode processing unit 420 executes the processing of steps S11 to S15 by the H.264 format for the input image by using the registers 421b to 425b.

Further, the encode processing unit 420 performs inverse quantization and inverse DCT conversion which is processing exclusively the H.264 encode for the input image (steps S41 and S42) and a loop filter reduces block noise (step S43). In addition, the encode processing unit 420 stores a processing result in a frame memory (step S44) and detects a motion based on data in the frame memory and a result of the color difference interleaving in step S13 (step S45). Further, in accordance with a result of the motion detection, the encode processing unit 420 performs motion estimation (step S46) or space estimation (step S47). In the H.264 format encode, the processing is performed by interframe comparison.

### [2-2-2] Operating Example of Terminal Apparatus of Second Example

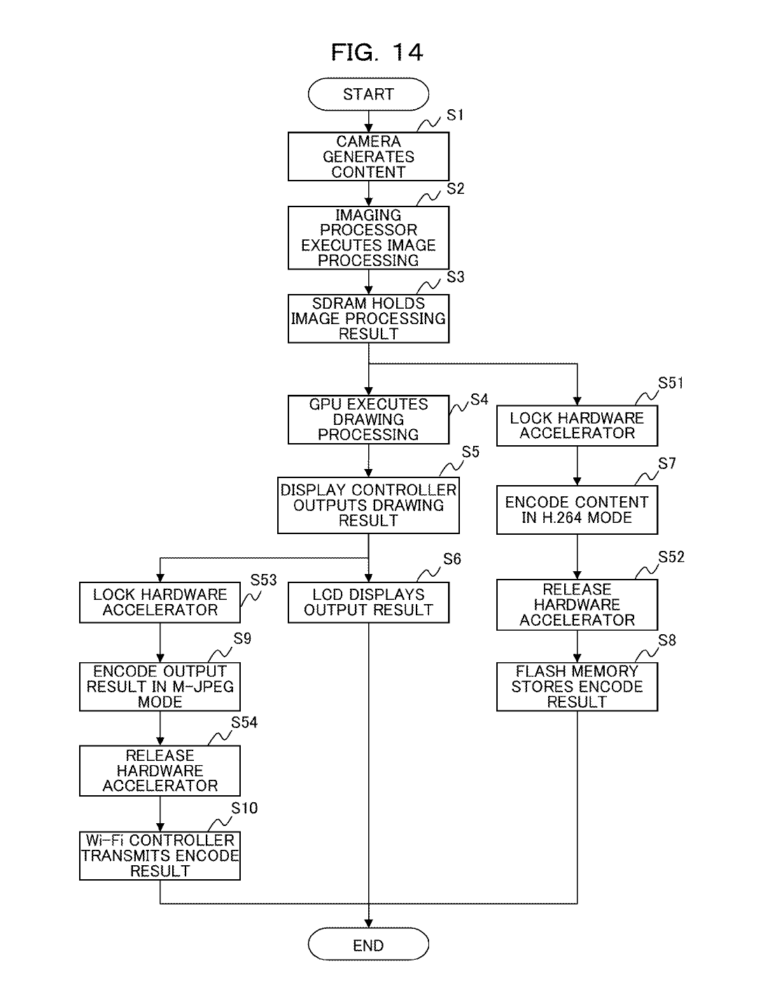

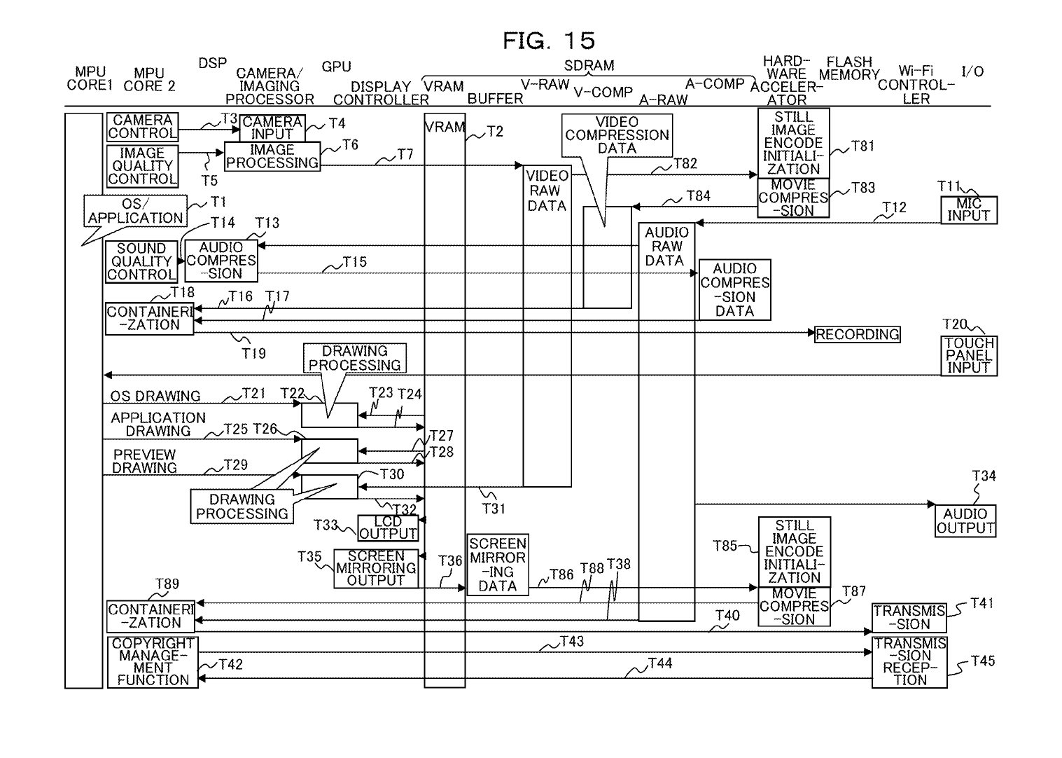

Next, the operating example of the terminal apparatus 10b configured as described above will be described with reference to FIGS. 14 and 15. FIGS. 14 and 15 are a flowchart and a sequence diagram describing operating examples of display processing, storage processing, and transmission processing of the content by the terminal apparatus 10b illustrated in FIG. 11. Note that, in the description of FIG. 14, since the same reference numerals as the reference numerals illustrated in FIG. 3 refer to the same or substantially the same processing, a detailed description thereof is omitted. In addition, in FIG. 15, processing T8 to T10 in FIG. 7 is substituted by processing T81 to T84 and processing T37 to T39 in FIG. 7 is substituted by processing T85 to T89. Hereinafter, the changed parts will be described.

As illustrated in FIG. 15, the hardware accelerator 42 initializes the movie encode (processing T81). In the initialization, processing such as locking of the hardware accelerator 42 (step S51 of FIG. 14) or switching to the used second register 420b is performed. In addition, in processing T7, the hardware accelerator 42 reads the video RAW data stored in the V-RAW area (processing T82). The hardware accelerator 42 performs H.264 format movie-compression for input video RAW data (processing T83) and stores a compression result in the V-COMP area (processing T84). Note that, when the movie compression is completed in processing T83, the hardware accelerator 42 releases locking (step S52 of FIG. 14).

Further, as illustrated in FIG. 15, the hardware accelerator 42 initializes encoding of a still image (processing T85). In the initialization, processing such as locking of the hardware accelerator 42 (step S53 of FIG. 14) or switching to the used first register 420a is performed. In addition, in processing T36, when the DMA subsystem 39 writes screen mirroring data in the buffer area of the SDRAM 52, the hardware accelerator 42 reads the screen mirroring data from the buffer area (processing T86). The hardware accelerator 42 performs M-JPEG format image compression for the read screen mirroring data (content) (processing T87) and transmits a compression result to the core 2 of the MPU 32 (processing T88). Note that, when the image compression is completed in processing T88, the hardware accelerator 42 releases locking (step S54 of FIG. 14).

Further, the core 2 of the MPU 32 containerizes the content image-compressed by processing T88, the audio RAW data read from the A-RAW area by processing T36, and the control signal (processing T89).

By the above processing, in the terminal apparatus 10b, the display processing, the storage processing, and the transmission processing of the content are executed.

As described above, the terminal apparatus 10b according to the second example may achieve the same effect as the terminal apparatus 10 according to the embodiment.

Further, according to the terminal apparatus 10b of the second example, the M-JPEG format encode processing depending on the content transmitted to the display device 20 is performed by the hardware accelerator 42. As a result, since processing for transmitting the content to the display device 20 may be executed to be completely separated from the operations of the application 11 and the OS, the influence which exerts on the operations of the application 11 and the OS may be significantly reduced.

In particular, since the MPU 32 for a smart phone or a tablet is lower than a PC in computing capability, when the software encode processing is executed, a load is large and the operations of the application 11 and the OS are influenced. Alternatively, in order to increase the computing capability of the MPU 32, a higher-performance and higher-cost MPU than a standard is selected.

As such, according to the terminal apparatus 10b of the second example, since the operations of the application 11 and the OS do not deteriorate and further, an increase in cost may be suppressed, convenience at the time of displaying the content displayed in the terminal apparatus 10b may be improved.

### [2-3] Third Example

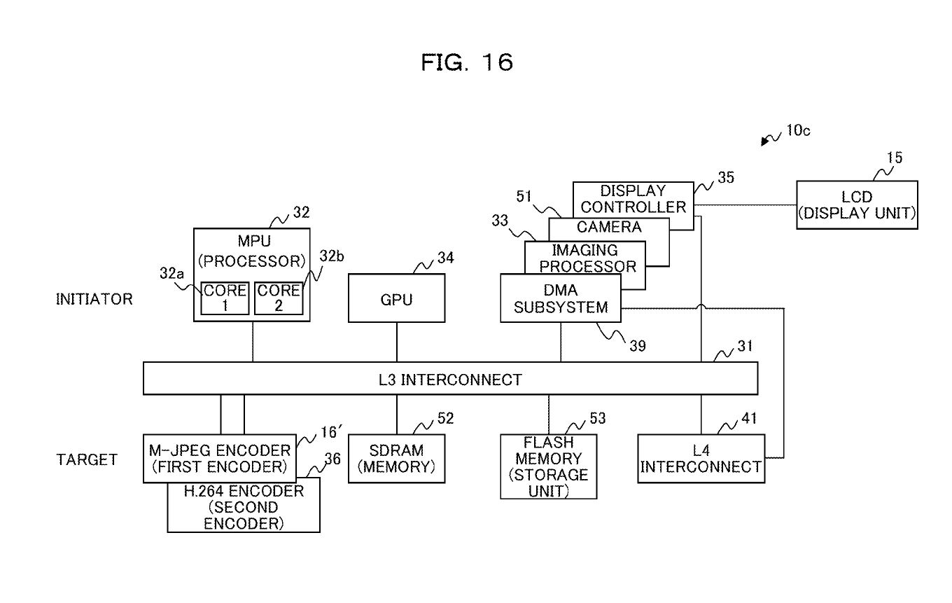

Next, a third example will be described with reference to FIGS. 16 to 18. In the third example, the encoder 16 is implemented by adding the hardware encoder of (3) described above.

### [2-3-1] Configuration Example of Terminal Apparatus of Third Example

First, a configuration example of a terminal apparatus 10c according to the third example will be described.

FIG. 16 is a diagram illustrating a hardware configuration example of the terminal apparatus 10c according to the third example. As illustrated in FIG. 16, the terminal apparatus 10c is different from the configuration of the terminal apparatus 10b of the second example illustrated in FIG. 11 in that the hardware accelerator 42 is substituted by an M-JPEG encoder 16′ and an H.264 encoder 36. Further, the terminal apparatus 10c is different from the configuration of the terminal apparatus 10b in that the GPU 34 is directly connected to the L3 interconnect 31, but since the terminal apparatus 10c is the same as the configuration of the terminal apparatus 10b in other points, a duplicated description is omitted. Note that, in FIG. 16, some blocks of the terminal apparatus 10 illustrated in FIG. 2 are not illustrated, for convenience.

The M-JPEG encoder 16′ is an additional video codec and executes the M-JPEG format encode processing by hardware. Note that, as described above, the M-JPEG format encode processing may omit processing such as interframe compression or motion correction. Therefore, since a small-sized circuit is just added even in the case where the M-JPEG encoder 16′ is added to, for example, a terminal apparatus that performs only the display processing and the storage processing of the content, the terminal apparatus 10c may be implemented without performing a significant design change.

### [2-3-2] Operating Example of Terminal Apparatus of Third Example

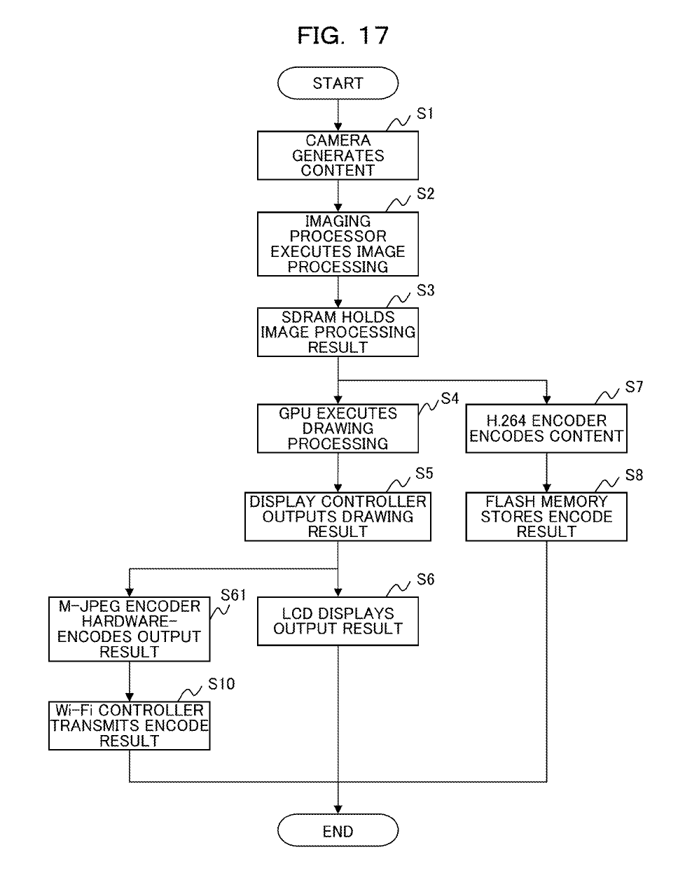

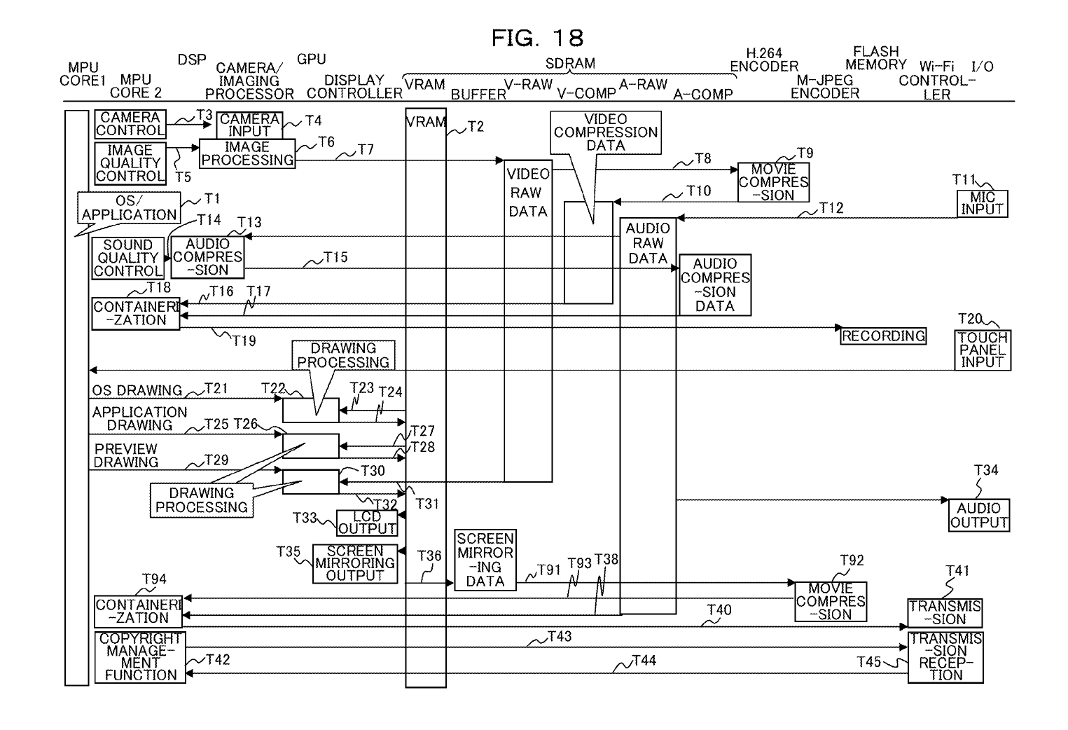

Next, the operating example of the terminal apparatus 10c configured as above will be described with reference to FIGS. 17 and 18. FIGS. 17 and 18 are a flowchart and a sequence diagram describing operating examples of display processing, storage processing, and transmission processing of the content by the terminal apparatus 10c illustrated in FIG. 16. Note that, in the description of FIG. 17, since the same reference numerals as the reference numerals illustrated in FIG. 3 refer to the same or substantially the same processing, a detailed description thereof is omitted. In addition, in FIG. 18, processing T37 and T39 in FIG. 7 is substitute by processing T91 to T94. Hereinafter, the changed parts will be described.

As illustrated in FIG. 18, in processing T36, when the DMA subsystem 39 writes screen mirroring data in the buffer area of the SDRAM 52, the M-JPEG encoder 16′ reads the screen mirroring data from the buffer area (processing T91). The M-JPEG encoder 16′ performs M-JPEG format image compression for an input screen mirroring output (content) (processing T92, and step S61 of FIG. 17) and transmits a compression result to the core 2 of the MPU 32 (processing T93).

Further, the core 2 of the MPU 32 containerizes the content image-compressed by processing T92, the audio RAW data read from the A-RAW area by processing T36, and the control signal (processing T94).

By the above processing, in the terminal apparatus 10c, the display processing, the storage processing, and the transmission processing of the content are executed.

As described above, the terminal apparatus 10c according to the third example may achieve the same effect as the terminal apparatus 10 according to the embodiment and the terminal apparatus 10b according to the second example.

### [2-4] In Regards to Communication Amount in SoC

Herein, the terminal apparatuses 10 (10a to 10c) illustrated in FIGS. 2, 5, 11, and 16, a communication amount of an internal bus of the SoC 3 is calculated.

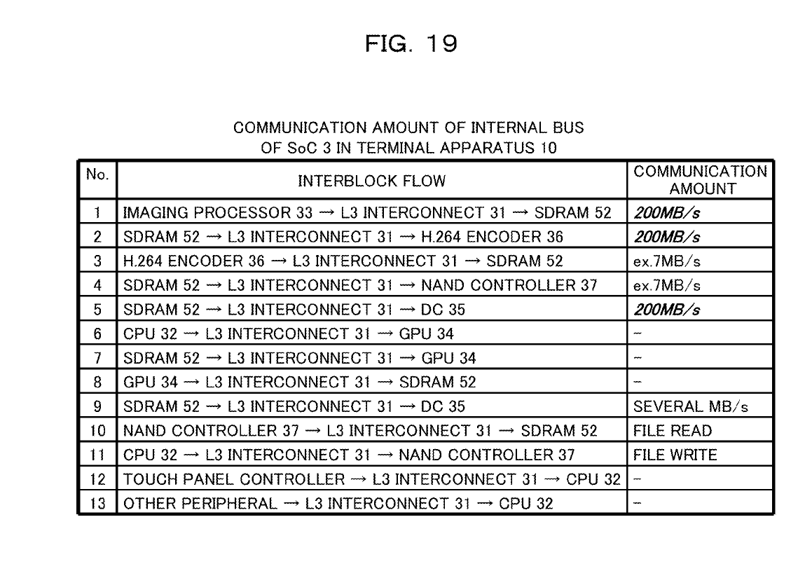

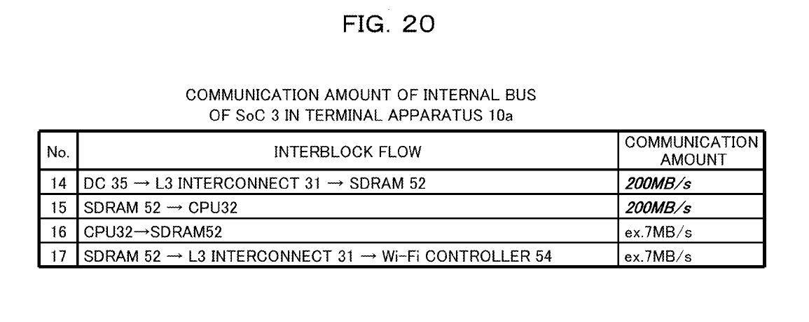

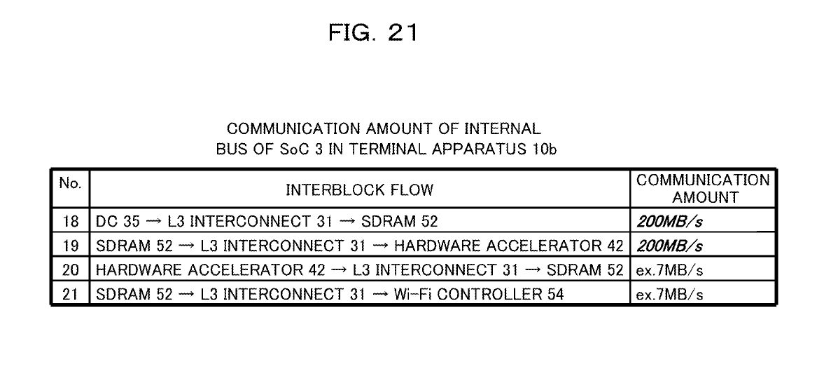

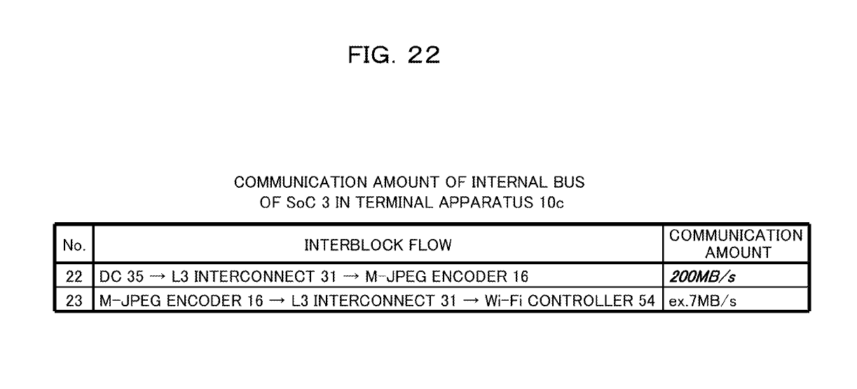

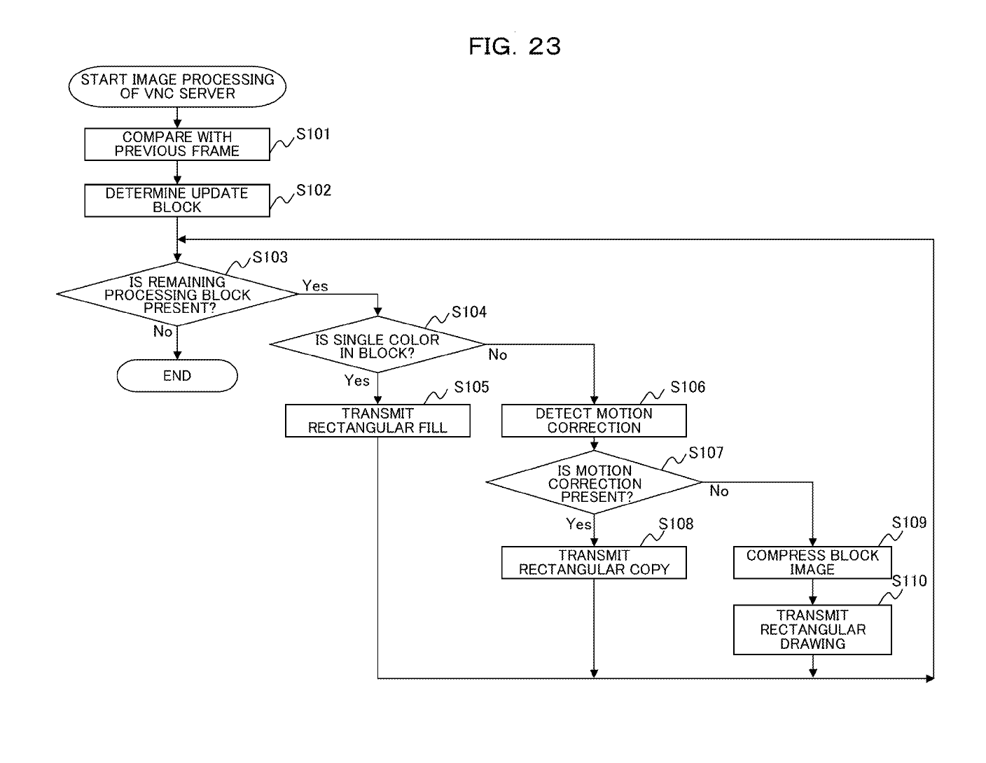

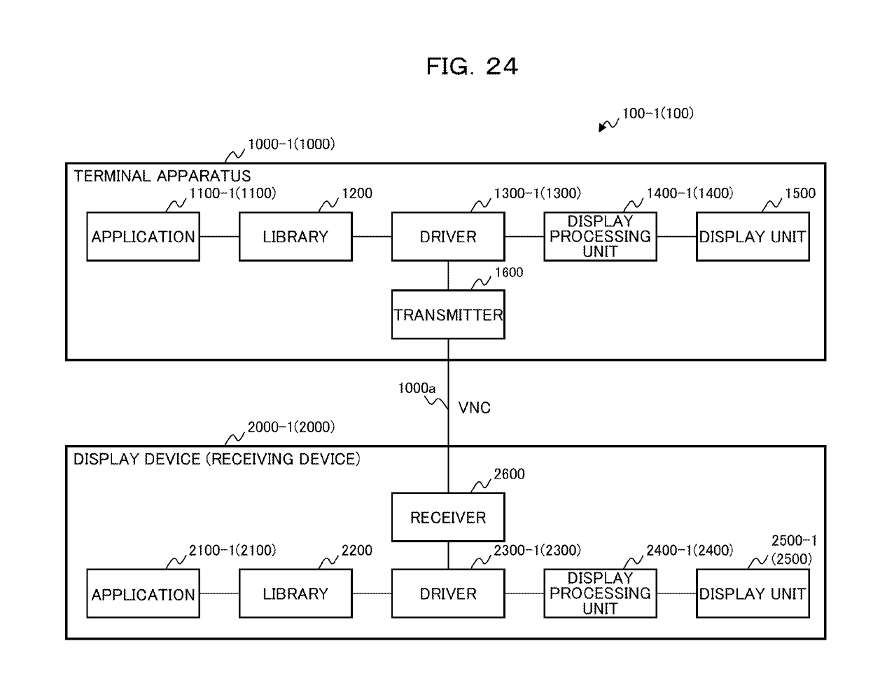

FIG. 19 is a diagram illustrating one example of the communication amount of the internal bus of the SoC 3 in the terminal apparatus 10 according to the embodiment and the first to third examples, and FIG. 20 is a diagram illustrating one example of the communication amount of the internal bus of the SoC 3 in the terminal apparatus 10a according to the first example. FIG. 21 is a diagram illustrating one example of the communication amount of the internal bus of the SoC 3 in the terminal apparatus 10b according to the second example, and FIG. 22 is a diagram illustrating one example of the communication amount of the internal bus of the SoC 3 in the terminal apparatus 10c according to the third example.

Note that, FIGS. 19 to 22 are diagrams illustrating the case where the communication amount of the internal bus of the SoC 3 is calculated in the case where processing including a high load such as movie photographing by the camera 51 is performed, in the terminal apparatuses 10 (10a to 10c).

For example, as illustrated in FIG. 19, Nos. 1, 2, and 5 are flows in which the communication amount is large as 200 MB/s and may be necks of communication in the interval bus of the SoC 3. That is, in each of the flows of Nos. 1, 2, and 5, communication may be performed by using the L3 interconnect 31. In other words, since all of the terminal apparatuses 10 (10a to 10c) according to the embodiment and the first to third examples use the L3 interconnects 31 in the internal buses of the flows of Nos. 1, 2, and 5, the communication amount of 200 MB/s may be secured.

Note that, in FIG. 19, a flow in which the communication amount is “-” is a flow in which a variation is large and it is difficult to calculate the communication amount, or a flow in which since the communication amount is small, a numerical value is omitted. Note that, a flow in which the communication amount is “File Read” or “File Write” is a flow in which since the variation in communication amount is large depending on reading or writing, but the communication amount is small, the numeral value is omitted.

Further, as illustrated in FIGS. 20 to 22, each of Nos. 14, 15, 18, 19, and 22 has the large communication amount of 200 MB/s. That is, since the respective terminal apparatuses 10 (10a to 10c) according to the first to third examples use the L3 interconnects 31 in the internal buses of the flows of Nos. 14, 15, 18, 19, and 22, the communication amount of 200 MB/s may be secured.

As such, in the embodiment and the first to third examples, the L3 interconnect 31 is used in a flow which becomes a neck of the communication when the processing including the high load is performed. In particular, as illustrated in FIGS. 20 to 22, the L3 interconnect 31 is used in communication to/from the M-JPEG encoder 16 (MPU 32′, the hardware accelerator 42, and the M-JPEG encoder 16′). Accordingly, the reduction of the communication amount may be suppressed and efficient screen mirroring may be performed between the terminal apparatus 10 and the display device 20.

(3) Others

As described above, although the embodiment of the invention has been described above, the invention is not limited to the specific embodiment and various modifications and changes can be made within the scope without departing from the spirit of the invention.

For example, in the embodiment and the first to third examples, the M-JPEG format is used as the encode format suitable for the mirroring, and the H.264 format is used as the encode format suitable for the movie, but the invention is not limited thereto and various encode formats may be used.

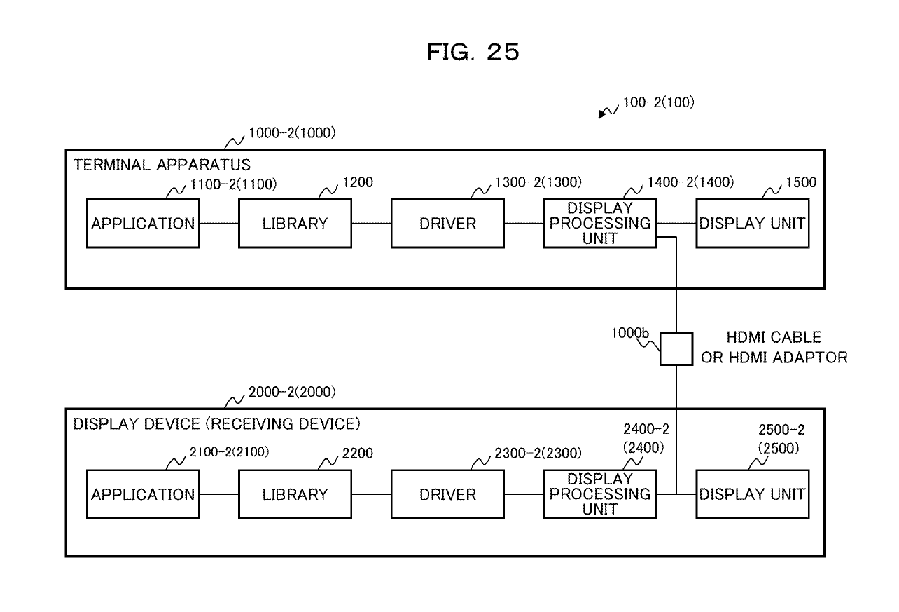

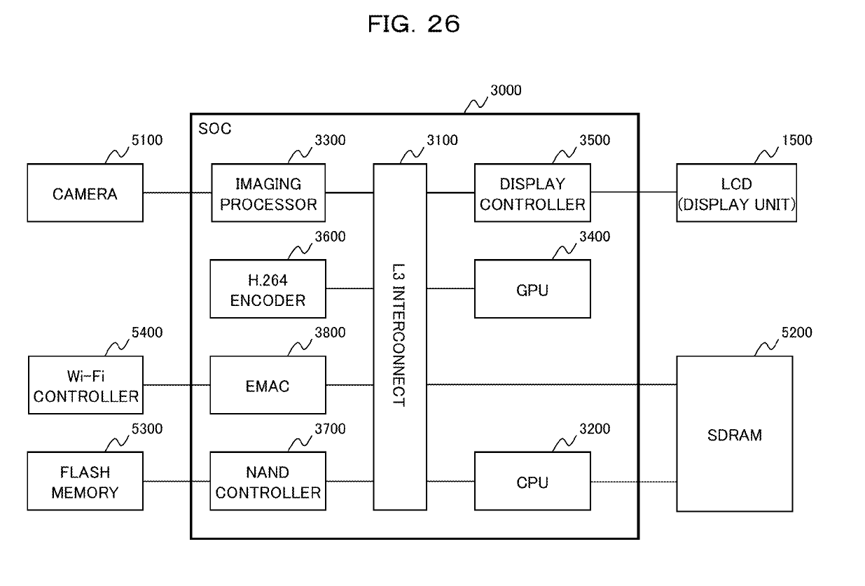

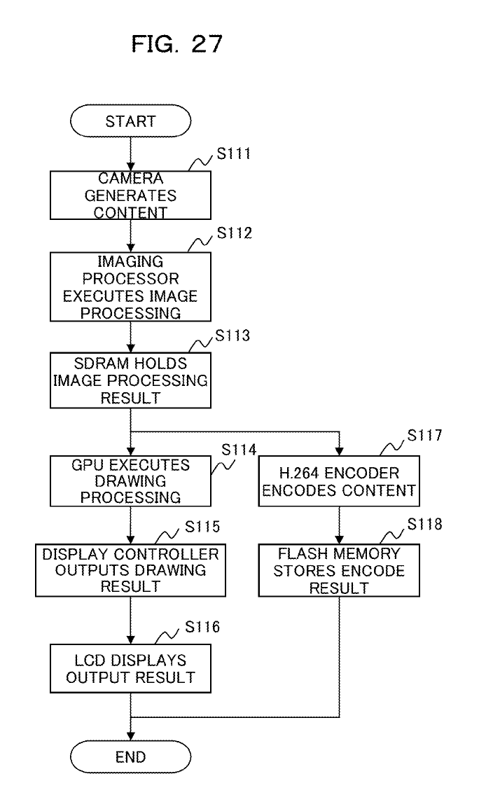

Further, in the embodiment and the first to third examples, the case in which the network 1a is Wi-Fi has been described, but the invention is not limited thereto. For example, the network 1a may be implemented by other wireless LANs or wired LANs (LAN cables). Note that, the case where the network 1a is the LAN cable has higher convenience than the case where the cable 1000b such as the HDMI cable illustrated in FIG. 25 is used in terms of a point in which a long cable is easily secured or a cost of the cable itself is low.

Further, in the second example, when the hardware accelerator 42 performs the time-division encode, the M-JPEG format which does not use the interframe comparison function is described as one encode format, but the invention is not limited thereto. For example, the hardware accelerator 42 may perform the time-division encode by two or more encode formats using the interframe comparison function. In this case, the first register 420a and the second register 420b may include a setting register for each function which is common in two or more encode formats.

Further, in the second example, the hardware accelerator 42 performs the time-division encode by two encode formats, but the invention is not limited thereto. For example, the hardware accelerator 42 may be configured by a multi-thread format of alternately processing two or more input streams by different encode formats. In this case, the hardware accelerator 42 may be designed to place each functioning unit as many as the optimal number.

Further, in the embodiment and the first to third examples, the GPU 34 and the DC 35 as one example of the display processing unit 14 are installed in the SoC 3, but the invention is not limited thereto and the GPU 34 and the DC 35 may be installed outside the SoC 3.

Note that, a computer (including at least one of terminal apparatus 10 (terminal apparatuses 10a to 10c) and the display device 20) may execute a predetermined program to implement all or some of various functions of the communication system 1 in the embodiment and the first to third examples.

The program is provided in a format recorded in computer-readable recording media such as a flexible disk, a CD (CD-ROM, CD-R, CD-RW, or the like), a DVD (DVD-ROM, DVD-RAM, DVD-R, DVD-RW, DVD+R, DVD+RW, or the like), a Blu-ray disk. In this case, the computer reads the program from the recording media and transmits the read program to an internal storage device or an external storage device and thereafter, stores and uses the transmitted program.

Herein, the computer is a concept including hardware and an operating system (OS) and means hardware which operates under a control from the OS. Further, when the OS is unnecessary, and thus an application program singly operates the hardware, the hardware itself corresponds to the computer. The hardware at least includes a microprocessor such as the CPU and unit for reading a computer program recorded in the recording medium. The program includes a program code to implement various functions of the embodiment and the first to third examples in the computer described above. Further, some of the functions may be implemented not by the application program but by the OS.

According to the disclosed technology, convenience at the time of displaying the content displayed in the terminal apparatus in the receiving device may be improved.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A terminal apparatus, comprising:
an integrated circuit in which a first encoder executing first encode processing for transmitting a content of which display processing is performed in a display processing unit to a receiving apparatus is installed.

2. The terminal apparatus according to claim 1, further comprising:
a memory holding a content;
a second encoder installed in the integrated circuit and executing second encode processing for storing the content held in the memory into a storage unit, and storing the content of which the second encode processing is executed in the storage unit; and
the display processing unit executing the display processing with respect to the content held in the memory.

3. The terminal apparatus according to claim 2, wherein:
the display processing unit holds the content of which the display processing is performed in the memory, and
the first encoder reads the content of which the display processing is performed, which is held in the memory to execute the first encode processing.

4. The terminal apparatus according to claim 3, wherein the display processing unit, the first encoder, and the memory are connected to interconnects, respectively.

5. The terminal apparatus according to claim 2, wherein the first encoder and the second encoder are constituted by one common third encoder.

6. The terminal apparatus according to claim 5, wherein the third encoder includes an encode processing unit that executes the first and second encode processing in time division.

7. The terminal apparatus according to claim 6, wherein:
the third encoder further includes
a first register holding status information in the first encode processing; and
a second register holding status information in the second encode processing, and
the encode processing unit executes the first and second encode processing in time division by using the first register and the second register.

8. The terminal apparatus according to claim 2, further comprising:
a processor installed in the integrated circuit and performing predetermined processing in the terminal apparatus, and executing the first encode processing,
wherein the processor serves as the first encoder.

9. The terminal apparatus according to claim 2, wherein the first encode processing is encode processing which is higher in compression rate than the second encode processing.

10. The terminal apparatus according to claim 1, further comprising:
a display unit displaying the content of which the display processing is completed in the display processing unit,
wherein the first encoder executes the first encode processing with respect to the content of which the display processing for display in the display unit is completed in the display processing unit.

11. The terminal apparatus according to claim 1, further comprising:
a transmitting unit transmitting the content of which the first encode processing is performed by the first encoder to the receiving apparatus.

12. The terminal apparatus according to claim 11, wherein the transmitting unit transmits the content to the receiving apparatus by wireless communication.

13. An integrated circuit, comprising:
a first encoder executing first encode processing for transmitting a content of which display processing is performed by a display processing unit to a receiving apparatus.

14. A computer-readable recording medium having stored therein a processing program for causing a computer having an integrated circuit installed with a processor to execute a process, the process comprising:
executing first encode processing for transmitting a content of which display processing is performed by a display processing unit to a receiving apparatus.

15. The computer-readable recording medium having stored therein a processing program according to claim 14, wherein:
the computer further includes a display unit displaying the content of which the display processing is completed, and
executes the first encode processing for the content of which the display processing for displaying in the display unit is completed.
